(19) United States
(12) Patent Application Publication
(10) Pub. No.: US 2015/0301609 A1
(43) Pub. Date: Oct. 22, 2015

(54) GESTURE RECOGNITION METHOD AND GESTURE RECOGNITION APPARATUS

(71) Applicant: Samsung Electronics Co., Ltd., Gyeonggi-do (KR)

(72) Inventors: Jeongmin PARK, Gyeonggi-do (KR); Eunjung HYUN, Seoul (KR); Seungeun LEE, Seoul (KR); Seungyoung JEON, Gyeonggi-do (KR); Jeongho CHO, Gyeonggi-do (KR)

(73) Assignee: Samsung Electronics Co., Ltd.

(21) Appl. No.: 14/693,524

(22) Filed: Apr. 22, 2015

(30) Foreign Application Priority Data
Apr. 22, 2014 (KR) 10-2014-0048216

(51) Int. Cl. G06F 3/01; G06F 3/041

(52) U.S. Cl. CPC G06F 3/017; G06F 3/041

(57) ABSTRACT

A gesture recognition method and apparatus are provided. The gesture recognition method includes extracting one or more vector values from an input gesture; generating a pattern of a vector based on the extracted one or more vector values; comparing the generated pattern to one or more patterns of stored vectors; and determining a type of the input gesture based on the comparing.

### PRIORITY

This application claims priority under 35 U.S.C. §119(a) to Korean Patent Application No. 10-2014-0048216, which was filed in the Korean Intellectual Property Office on Apr. 22, 2014, the content of which is incorporated herein by reference.

### BACKGROUND OF THE INVENTION

1. Field of the Invention

The present invention relates generally to a method and an apparatus for recognizing a gesture in an electronic device.

2. Description of the Prior Art

An electronic device may recognize a gesture by detecting intensity of light (e.g., an infrared ray) reflected by an object through an infrared sensor and determining a distance and an operation of the gesture. Through a hovering technology, a Touch Screen Panel (TSP) of an electronic device may detect the motion of an object (for example, a finger of a user or a stylus pen) on a screen and recognize a hovering gesture. Specifically, the user inputs a gesture in a certain direction based on locations of various sensors (for example, a gesture recognition sensor) to perform a specific instruction corresponding to the gesture. For example, when the user inputs a circular pattern, the electronic device may perform an operation corresponding to the circular pattern by accurately inputting the circular pattern with reference to a sensor.

However, when the user desires to input a specific pattern to perform a specific instruction while the electronic device is positioned above the user's hand, (for example, when the electronic device is located on a desk), it may be uncomfortable for the user to input the specific pattern while raising their arm and bending their wrist.

### SUMMARY OF THE INVENTION

The present invention has been made to address at least the problems and/or disadvantages described above and to provide at least the advantages described below.

Accordingly, an aspect of the present invention is to provide a method and an apparatus for effectively recognizing an operation intended by a user.

In accordance with an aspect of the present invention, a gesture recognition method is provided, which includes extracting one or more vector values from an input gesture; generating a pattern of a vector based on the extracted one or more vector values; comparing the generated pattern to one or more patterns of stored vectors; and determining a type of the input gesture based on the comparing.

In accordance with another aspect of the present invention, a gesture recognition method is provided, which includes detecting two or more multiple proximity inputs; extracting one or more first vector values from the detected two or more multiple proximity inputs; detecting a motion of the detected two or more multiple proximate inputs; extracting one or more second vector values for the motion; analyzing loci of the first vector values and the second vector values; determining whether a pinch gesture is generated, based on the analyzed loci; and if the pinch gesture is generated, performing a function corresponding to the pinch gesture.

In accordance with another aspect of the present invention, a gesture recognition apparatus is provided, which includes a gesture recognition device; and a controller that detects an input of a gesture through the gesture recognition device, extracts one or more vector values from the detected gesture, generates a pattern of a vector based on the extracted one or more vector values, compares the generated pattern of the vector to one or more patterns of stored vectors, and determines a type of the gesture, based on the comparison.

In accordance with another aspect of the present invention, a gesture recognition apparatus is provided, which includes a gesture recognition device; and a controller that detects two or more multiple proximity inputs through the gesture recognition device, extracts one or more first vector values for the multiple proximity inputs, detects a motion generated by the multiple proximate inputs, extracts one or more second vector values from the motion, analyzes loci of the first vector values and the second vector values, determines whether a pinch gesture is generated, based on the analyzed loci, and performs a function corresponding to the pinch gesture, when the pinch gesture is generated.

### BRIEF DESCRIPTION OF THE DRAWINGS

The above and other aspects, features, and advantages of certain embodiments of the present invention will be more apparent from the following detailed description in conjunction with the accompanying drawings, in which:

FIG. 1 illustrates a network environment including an electronic device according to an embodiment of the present invention;

FIG. 2 illustrates an electronic device according to an embodiment of the present invention;

FIGS. 3A to 3G illustrate examples of a gesture recognition method according to an embodiment of the present invention;

FIG. 4 is a flowchart illustrating a gesture recognition method according to an embodiment of the present invention;

FIGS. 5A to 5B illustrate examples of a gesture recognition method according to an embodiment of the present invention;

FIG. 6 is a flowchart illustrating a gesture recognition method according to an embodiment of the present invention;

FIGS. 7A to 7E illustrate examples of a gesture recognition method according to an embodiment of the present invention;

FIG. 8 is a flowchart illustrating a gesture recognition method according to an embodiment of the present invention;

FIGS. 9A to 9D illustrate examples of a gesture recognition method according to an embodiment of the present invention;

FIG. 10 is a flowchart illustrating a gesture recognition method according to an embodiment of the present invention;

FIGS. 11A to 11D illustrate examples of a gesture recognition method according to an embodiment of the present invention;

FIG. 12 is a flowchart illustrating a gesture recognition method according to an embodiment of the present invention;

FIGS. 13A to 13C illustrate examples of a gesture recognition method according to an embodiment of the present invention;

FIG. 14 illustrates a gesture recognition method according to an embodiment of the present invention; and

FIG. 15 illustrates an electronic device according to an embodiment of the present invention.

### DETAILED DESCRIPTION OF EMBODIMENTS OF THE PRESENT INVENTION

Various embodiments of the present invention will now be described more fully in conjunction with the accompanying drawings. The present invention may have various embodiments, and modifications and changes may be made therein. Therefore, the present invention will be described in detail with reference to particular embodiments shown in the accompanying drawings. However, it should be understood that there is no intent to limit various embodiments of the present invention to the particular embodiments disclosed, but the present invention should be construed to cover all modifications, equivalents, and alternatives falling within the spirit and scope of the various embodiments of invention. In connection with descriptions of the drawings, similar components are designated by the same reference numeral.

It will be understood that the expressions “comprises” and “may comprise” are used to indicate the presence of a disclosed function, operation, component, etc., but do not preclude the presence of one or more functions, operations, components, etc. It will be further understood that the terms “comprises” and/or “has” when used in this specification, specify the presence of stated feature, number, step, operation, component, element, or a combination thereof, but do not preclude the presence or addition of one or more other features, numbers, steps, operations, components, elements, or combinations thereof. In the present disclosure, the expression “and/or” is taken as specific disclosure of each and any combination of enumerated things. For example, A and/or B is to be taken as specific disclosure of each of A, B, and A and B.

As used herein, terms such as “first,” “second,” etc., are used to describe various components; however, it is obvious that the components should not be defined by these terms. For example, the terms do not restrict the order and/or importance of the corresponding components. The terms are used only for distinguishing one component from another component. For example, a first component may be referred to as a second component and likewise, a second component may also be referred to as a first component, without departing from the teaching of the inventive concept.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise.

Unless otherwise defined herein, all terms including technical or scientific terms used herein have the same meanings as commonly understood by those skilled in the art to which the present invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

An electronic device according to various embodiments of the present invention may be an apparatus including a gesture recognition function, and may also include devices having an operation support function. For example, an electronic device may include a smartphone, a table Personal Computer (PC), a mobile phone, a video phone, an electronic book (e-book) reader, a desktop PC, a laptop PC, a netbook computer, a Personal Digital Assistant (PDA), a Portable Multimedia Player (PMP), an MP3 player, a mobile medical appliance, a camera, and a wearable device (e.g., head-mounted device (HMD) such as an electronic glasses, electronic clothing, an electronic bracelet, an electronic necklace, an electronic appcessory, an electronic tattoo, a smartwatch, etc.).

Additionally, an electronic device may be a smart home appliance having an operation support function, such as a television, a Digital Video Disk (DVD) player, an audio player, a refrigerator, an air-conditioner, a vacuum cleaner, an electric oven, a microwave oven, a laundry machine, an air cleaner, a set-top box, a TV box (e.g., Samsung HomeSync®, apple TV®, and google TV®), a game console, an electronic dictionary, an electronic key, a camcorder, an electronic frame, etc.

Other examples of an electronic device include a medical device (e.g., a Magnetic Resonance Angiography (MRA) device, a Magnetic Resonance Imaging (MRI) device, a Computed Tomography (CT) device), a Navigation device, a Global Positioning System (GPS) receiver, an Event Data Recorder (EDR), a Flight Data Recorder (FDR), a car infotainment device, a maritime electronic device (e.g., a maritime navigation device and a gyro compass), an aviation electronic device (avionics), a security device, a vehicle head unit, an industrial or home robot, an Automatic Teller Machine (ATM) of a financial institution, a Point Of Sales (POS) device, etc.

Other examples of an electronic device may include furniture and buildings/structures having a communication function, an electronic board, an electronic signature receiving device, a projector, and a metering device (e.g., water, electric, gas, and/or electric wave metering devices).

Additionally, the electronic device may be a flexible device.

Further, an electronic device may be any combination of the aforementioned devices.

It is obvious to those skilled in the art that an electronic device is not limited to the aforementioned examples.

Herein, the term “user” may denote a person or a device (e.g., an artificial intelligent electronic device) using an electronic device.

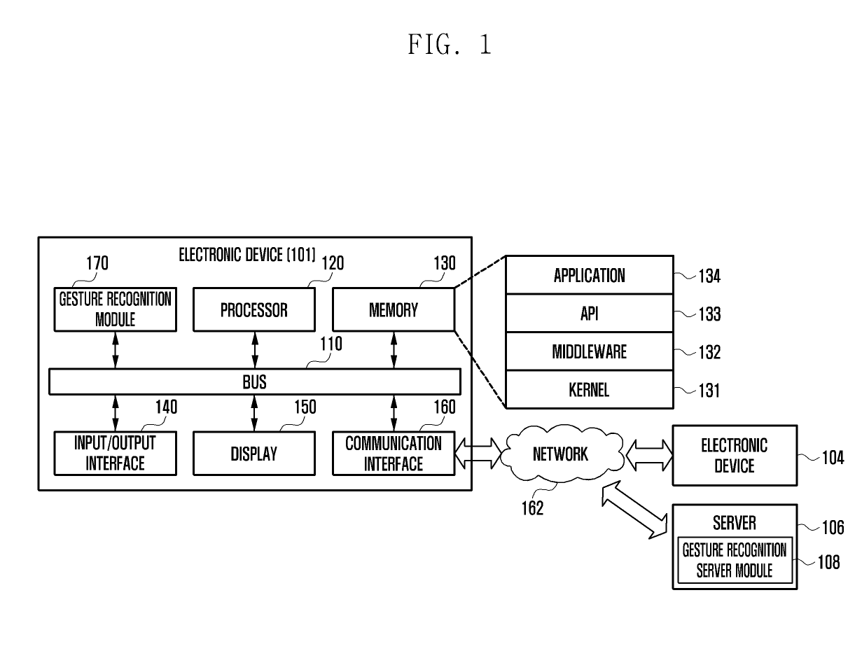

FIG. 1 illustrates a network environment including electronic devices according to an embodiment of the present invention.

Referring to FIG. 1, an electronic device 101 includes a bus 110, a processor 120, a memory 130, an input/output interface 140, a display 150, a communication interface 160, and a gesture recognition module 170.

The bus 110 connects the aforementioned components to each other and may be a circuit for exchanging signals (e.g., control messages) among the components.

For example, the processor 120 receives a command from any of the aforementioned components (e.g., the memory 130, the input/output interface 140, the display 150, the communication interface 160, and the gesture recognition module 170) through the bus 110, interprets the command, and executes operation or data processing according to the decrypted command.

The memory 130 stores the command or data received from the processor 120 or other components or generated by the processor 120 or other components. The memory 130 stores program modules including a kernel 131, middleware 132, an Application Programming Interface (API) 133, applications 134, etc. Herein, each programming module may be implemented as software, firmware, hardware, and any combination thereof.

The kernel 131 controls or manages the system resources (e.g. bus 110, processor 120, and memory 130) for use in executing an operation or a function implemented with the middleware 132, the API 133, and/or the application 134. The kernel 131 also provides an interface for the middleware 132, API 133, and/or application 134 to access the components of the electronic device 101 to control or manage.

The middleware 132 may work as a relay of data communicated between the API 133 or application 134 and the kernel 131. The middle 132 may also execute control of the task requests from the applications 134 in such a way of assigning priority for use of the system resources (e.g., bus 110, processor 120, and memory 130) of the electronic device 101 to at least one of the applications 134.

The API 133 is an interface for the applications 134 to control the function provided by the kernel 131 or the middleware 132, and may include at least one interface or function (e.g., a command) for file control, window control, image control, or text control.

For example, the applications 134 may include a Short Messaging Service/Multimedia Messaging Service (SMS/MMS) application, an email application, a calendar application, an alarm application, a health care application (e.g., an application for measuring motion or a blood sugar level), and an environmental information application (e.g., atmospheric pressure, humidity, and/or temperature applications). Additionally or alternatively, the application 134 may be an application related to information exchange between the electronic device 101 and other external electronic devices (e.g., an electronic device 104 or a server 106). Examples of the information exchange application may include a notification relay application for relaying specific information to the external electronic device and a device management application for managing the external electronic device.

For example, the notification relay application may be provided with a function of relaying the alarm information generated by the other applications (e.g., an SMS/MMS application, an email application, a health care application, and an environmental information application) of the electronic device 101 to the electronic device 104.

Additionally or alternatively, the notification relay application may provide the user with the notification information received from the electronic device 104. The electronic device application may manage (e.g., install, delete, or update) a function of the electronic device 104 (e.g. turn-on/off of the electronic device 104 (or a component thereof) or adjust the brightness (or resolution) of another display), which communicates with the electronic device 101, or manage a service (e.g., communication or messaging service) provided by the electronic device 104.

For example, the applications 134 may include an application designated according to a property (e.g., a type) of an external electronic device (e.g., the electronic device 104).

If the electronic device 104 is an MP3 player, the application 134 may include a music playback application. Similarly, if the electronic device 104 is a mobile medical appliance, the application 134 may include a heal care application.

As another example, the application 134 may include at least one of an application designated to the electronic device 101 or an application received from an external electronic device (e.g., the server 106 or the electronic device 104).

The input/output interface 140 delivers a command or data input by a user through an input/output device (e.g., a sensor, a keyboard, and/or a touch screen) to the processor 120, memory 130, communication interface 160, and/or gesture recognition module 170 through the bus 110. For example, the input/output interface 140 provides the processor 120 with data corresponding to a touch made by a user on the touch screen.

The input/output interface 140 may output a command or data, which is received from the processor 120, memory 130, communication interfaced 160, and/or the gesture recognition module 170 through the bus 110, through an input/output device (e.g., a speaker and/or a display). For example, the input/out interface 140 may output the voice data processed by the processor 120 to the user through a speaker.

The display 150 displays various information (e.g., multimedia data and text data) to the user.

The communication interface 160 establishes a communication connection of the electronic device 101 with an external device (e.g., the electronic device 104 and/or the server 106). For example, the communication interface 160 connects to a network 162 through a wireless or wired link for communication with the electronic device 104. Examples of the wireless communication technology may include wireless fidelity (Wi-Fi), Bluetooth (BT), Near Field Communication (NFC), Global Positioning System (GPS), and cellular communication technology (e.g., Long Term Evolution (LTE), LTE-Advanced (LTE-A), Code Division Multiple Access (CDMA), Wideband CDMA (WCDMA), Universal Mobile Telecommunication System (UMTS), Wireless-Broadband (WiBro), and General System for Mobile communications (GSM)). Examples of the wired communication technology may include Universal Serial Bus (USB), High Definition Multimedia Interface (HDMI), Recommended Standard 232 (RS-232), and Plain Old Telephone Service (POTS).

The network 162 may be a telecommunication network including at least one of a computer network, the Internet, the Internet of Things, and/or a telephone network.

A communication protocol (e.g., a transport layer protocol, a data link layer protocol, and/or a physical layer protocol) between the electronic device 101 and an external device may be supported by at least one of the applications 134, the API 133, the middleware 132, the kernel 131, and the communication interface 160.

The server 106 may support driving of the electronic device 101 by performing at least one of operations (or functions) implemented by the electronic device 101. For example, the server 106 may include a gesture recognition server module 108 that may support a gesture recognition module 170 realized in the electronic device 101. For example, the gesture recognition server module 108 may include at least one element of the gesture recognition module 170 to perform handle at least one of the operations performed by the gesture recognition module 170.

The gesture recognition module 170 may process information acquired from other elements (e.g., the processor 120, the memory 130, the input/output interface 140, and the communication interface 160), and may provide the processed information to a user through various methods. For example, the gesture recognition module 170 may control at least some functions of the electronic device 101 such that the electronic device 101 interworks with another electronic device (e.g., the electronic device 104 or the server 106) using the processor 120 or independently from the processor 120.

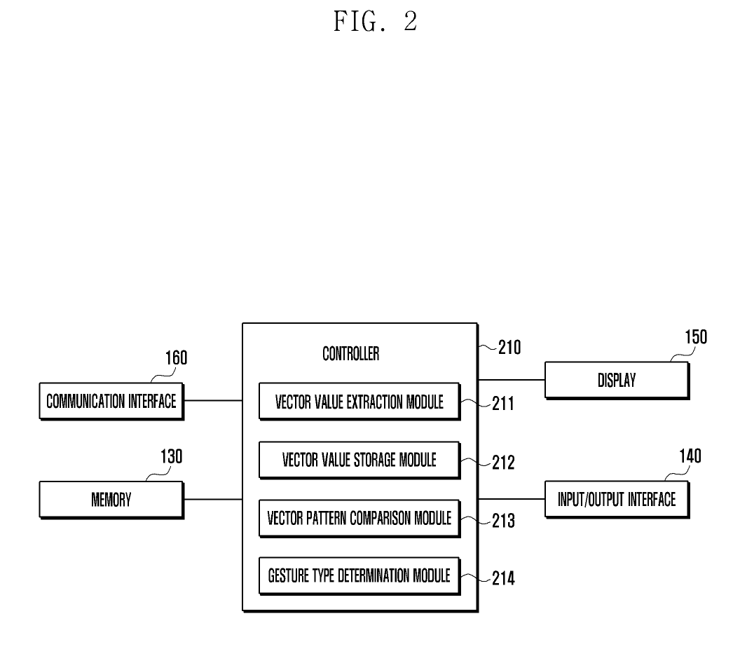

FIG. 2 illustrates an electronic device according to an embodiment of the present invention.

Referring to FIG. 2, the electronic device includes a controller 210, a memory 130, an input/output interface 140, a display 150, and a communication interface 160. For example, the controller 210 may be a processor (for example, an application processor (API)) or a hardware module, a software module or a combination thereof controlled by the processor. For example, the controller 210 may include a control logic corresponding to at least some functions of the gesture recognition module 170, which are executed by the processor 120. The gesture recognition module 170 of the controller 210 may include a vector value extraction module 211 for recognizing a detected gesture, a vector value storage module 212, a vector pattern comparison module 213, and a gesture type determination module 214

The controller 210 generates a vector pattern for a generated gesture, and compares a vector pattern for the gesture with a stored vector pattern to determine the type of the gesture and perform a function for the gesture.

Accordingly, in a module operation of the controller 210, the vector value extraction module 211 may extract a vector value for a generated gesture. The vector value storage module 212 may store a vector value extracted through the vector value extraction module 211. The vector pattern comparison module 213 may compare a vector pattern for the generated gesture with a stored vector pattern in the memory 130. The gesture type determination module 214 may determine the type of the gesture through the comparison operation.

The memory 130 may store a vector pattern of a comparison target to determine the type of the gesture. The memory 130 may store the vector pattern for the detected gesture.

The input/output interface 140 may include, for example, an input unit (for example, an input/output interface 140) such as a touch panel or a key button panel. The touch panel may include a touch screen such that the touch screen is integral with the display 150, and may detect inputs touched on the display 150.

For example, the controller 210 may include the gesture recognition module 170, and may determine a gesture of the user through a gesture sensor such as an IR sensor, hovering through TSP, and/or an image sensor. The gesture recognition module 170 may determine an object (for example, a finger of the user or a stylus pen) that is a motion target, when a gesture of the user is detected, and may detect a motion of the object. Thereafter, when a motion of the object is detected, the gesture recognition module 170 may detect a motion on the z-axis corresponding to depth, and motions on the x and y axes, when the motion of the object is detected. That is, when a motion is detected while the gesture is generated, a vector value for the motion in the form of (x, y, z) axes may be extracted.

In accordance with an embodiment of the present invention, the vector value may include at least one phase value. Motion information in which the extracted vector values in the form of (x, y, z) are accumulated may be compared with a predefined motion (stored in the 3-dimensional form of (x, y, z). Specifically, a distribution of vector values for a predefined motion may be compared with a distribution for vector values for a gesture.

Further, a progress direction in which vector values for a predefined motion are generated may be compared with a progress direction in which vector values for a gesture are generated. Through the comparison operations, the type of gesture of the user may be determined, and a function corresponding to the type of gesture may be performed.

When a gesture is detected while the electronic device is horizontal, vertical, or inclined, gestures in various states may be recognized as the same gesture by comparing the distribution of the vector values for the gesture and the progress direction in which the vector values are generated.

The controller 210 may control to extract at least one vector value for a detected gesture, to generate a pattern of a vector based on the vector value, to compare the pattern of the at least one vector stored in advance with the pattern of the generated vector, and to determine the type of the gesture based on the comparison process.

When a pattern of the vector is generated, the controller 210 may classify the pattern of the vector through at least one of variance, deviation, and average of the vector values.

The controller 210 may compare the distribution of the vector values and the progress direction in which the vector values are generated.

When a new gesture is detected, the controller 210 may extract at least one vector value for the new gesture.

As the new gesture is detected, the controller 210 may accumulate and store vector values for the new gestures.

The controller 210 may detect the gesture through at least one of an image sensor, an IR sensor, and a touch panel.

The controller 210 may also control to, when at least two multiple proximity inputs are detected, extract at least one first vector value for the multiple proximity inputs, to extract at least one second vector value for the motion, if a motion is generated while the multiple proximity inputs are detected, to analyze motion loci of the first vector value and the second vector values, to determine generation of a pinch gesture (pinch in or pinch out), and to perform a function corresponding to the pinch gesture.

The controller 210 may perform at least one of functions of enlarging and reducing an image and adjusting a selection range of materials arranged on the Z-axis, when the pinch gesture is generated.

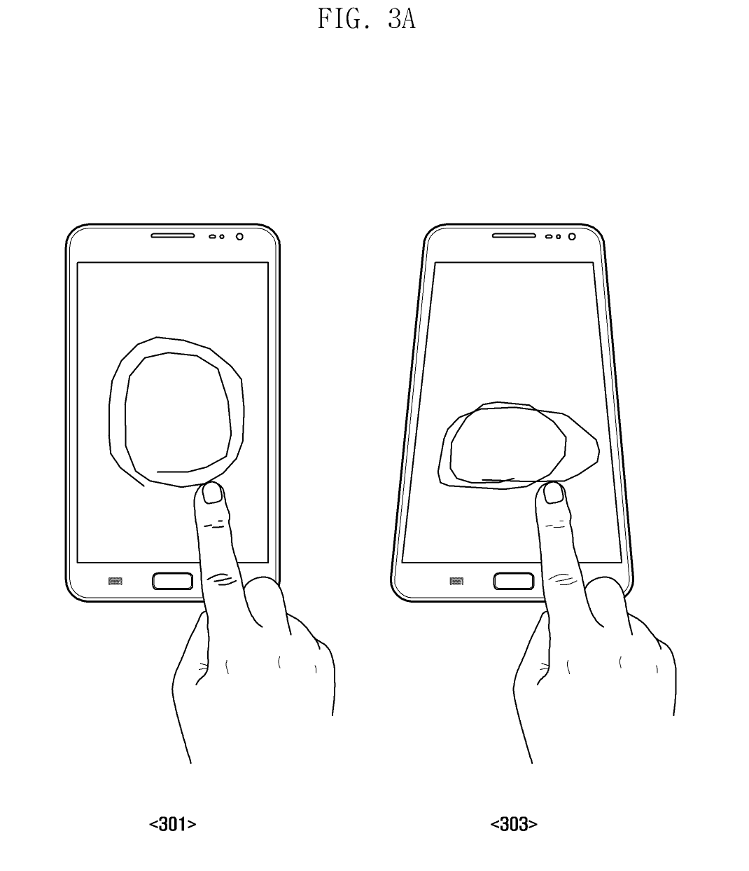

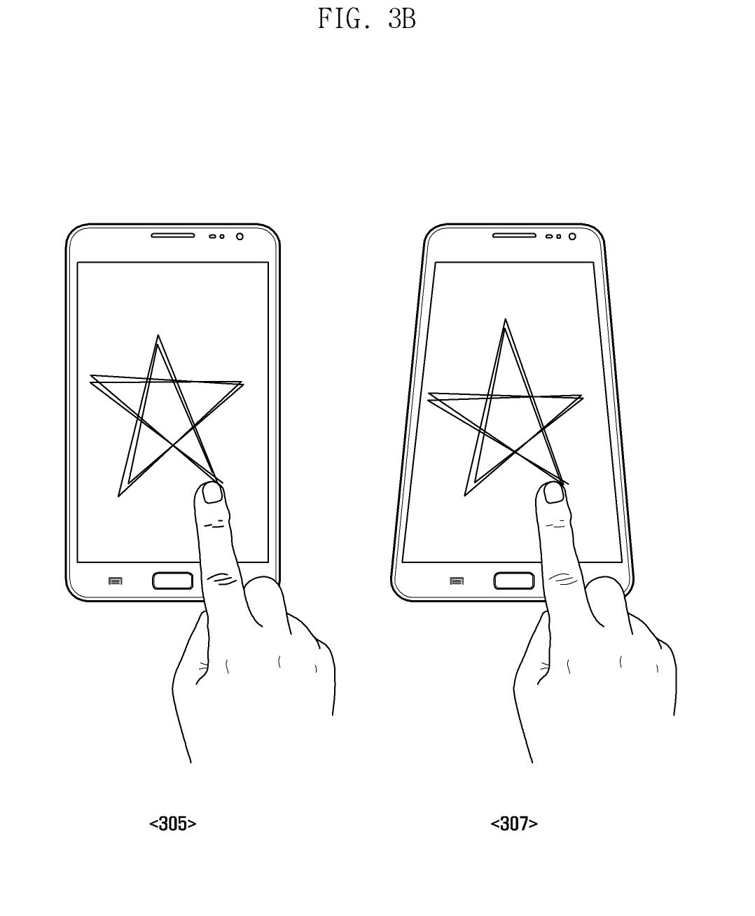

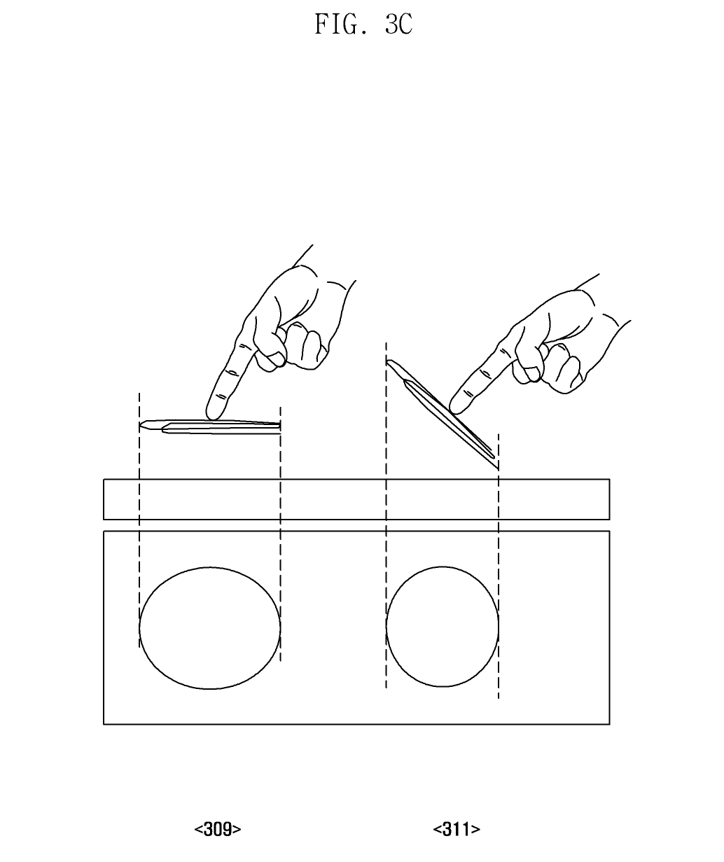

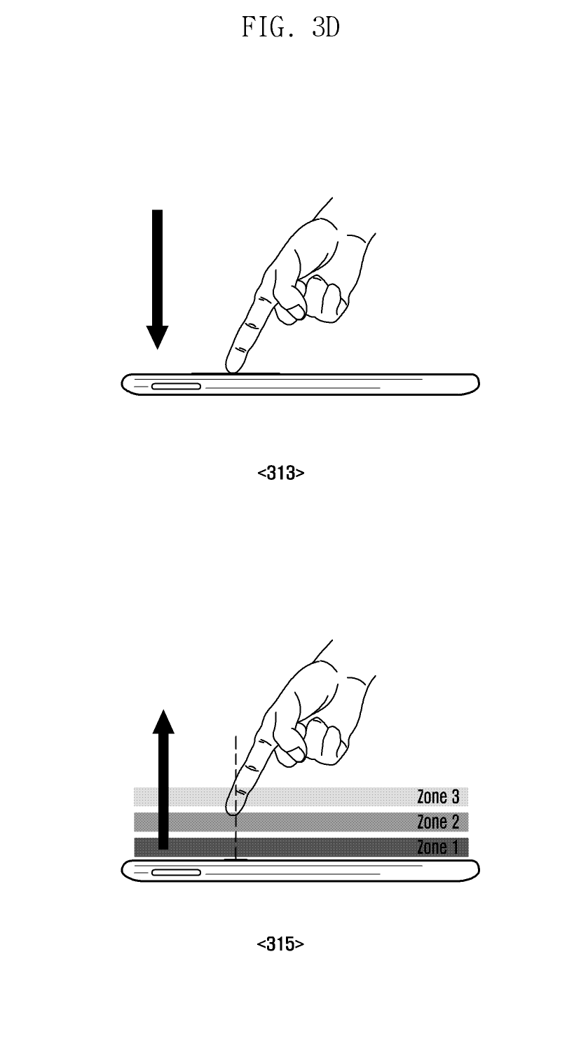

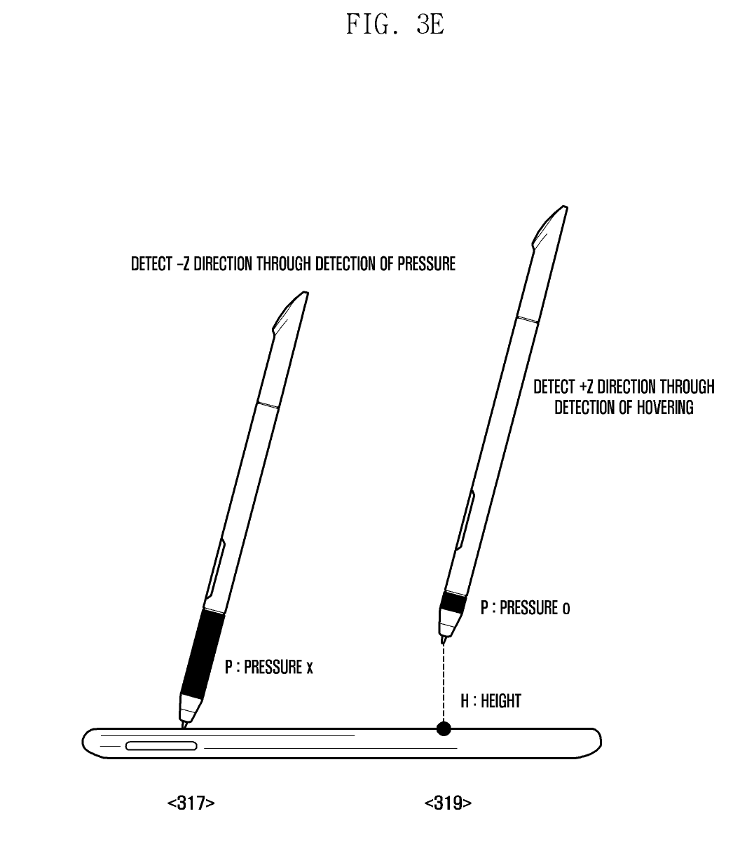

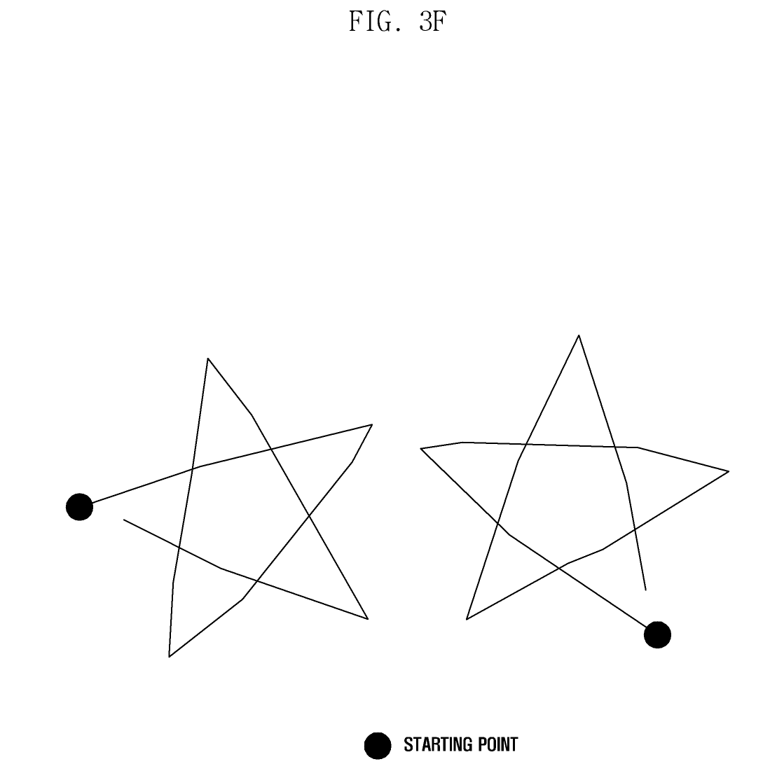

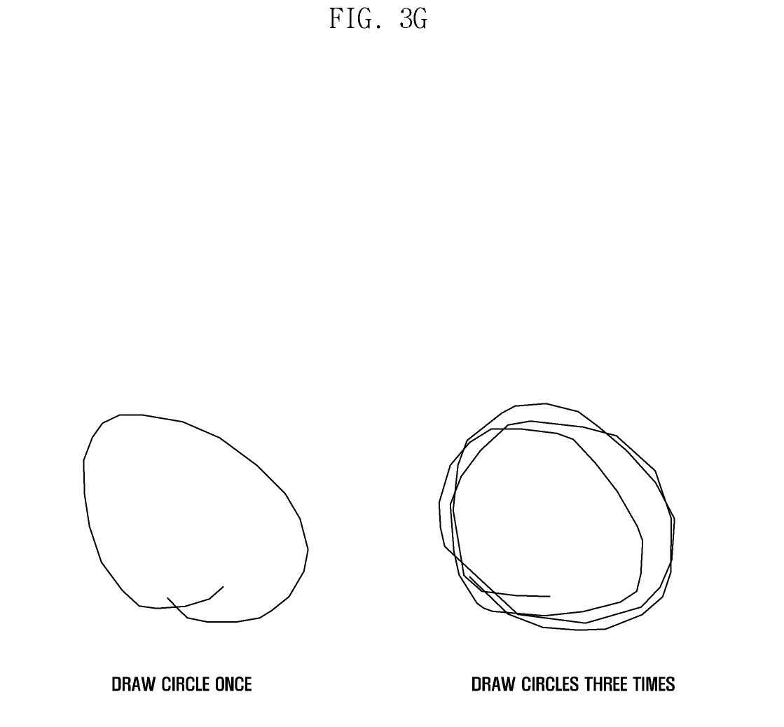

FIGS. 3A to 3G illustrate examples of a gesture recognition method according to an embodiment of the present invention.

Referring to FIGS. 3A to 3G, the gesture recognition module 170 detects a gesture input of the user. For example, the gesture input may include a continuous figure pattern such as a circular pattern, an 8-shaped pattern, or a star-shaped pattern.

Referring to FIG. 3A, the gesture recognition module 170 detects a circular gesture input of the user while the electronic device is horizontal, i.e., the hover input is on a parallel plane with respect to the touch screen of the electronic device, as indicted by reference numeral 301. Further, the gesture recognition module 170 may detect a circular gesture input by the user while the electronic device is inclined, i.e., the hover input is on an angled plane with respect to the touch screen of the electronic device, as indicated by reference numeral 303.

Referring to FIG. 3B, the gesture recognition module 170 detects a star-shaped gesture input by the user while the electronic device is horizontal, as indicted by reference numeral 305 of FIG. 3B. Further, the gesture recognition module 170 detects a star-shaped gesture input by the user while the electronic device is inclined, as indicated by reference numeral 307 of FIG. 3B.

As illustrated in FIGS. 3A and 3B, when a circular gesture input or a star-shaped gesture input of the user is detected while the electronic device is horizontal or inclined, the user may recognize that the same circular gesture or star-shaped gesture is drawn, but the electronic device may recognize the gesture as having another shape. That is, two operations (i.e., detecting a gesture input while the electronic device is horizontal and detecting a gesture input while the electronic device is inclined) may be recognized as different signals by the gesture recognition module 170.

For example, if the input gesture is viewed only through the x and y-axes, a sensor may recognize the gesture as being close to a circle as indicated by reference numeral 309 of FIG. 3C, while the electronic device is horizontal, and may recognize the gesture as being elliptical as indicated by reference numeral 311 of FIG. 3C, while the electronic device is inclined. According to an embodiment of the present invention, z-axis information may be sensed for more accurate recognition of a gesture.

If a finger of the user applies pressure to a display, as indicated by reference numeral 313 of FIG. 3D, for recognition in the z-axis direction, a value on the −z-axis that is smaller than 0 may be determined according to the pressure. However, if the finger of the user inputs a hover input over the display, as indicated by reference numeral 315 of FIG. 3D, a value in the +z-direction may be determined according to a distance at which the finger of the user hovers over the display.

According to another embodiment of the present invention, z-axis information may be sensed through input by a stylus pen (S-Pen).

Referring to FIG. 3E, if pressure (a pressure value is x) is applied to a display by a stylus pen, as indicated by reference numeral 317, a value in the −z-axis direction that is smaller than 0 may be determined according to the pressure. However, as indicated by reference numeral 319 of FIG. 3E, a value in the +z-direction may be determined according to a distance at which the stylus pen hovers (the pressure value is 0) over the display.

By sensing x, y, and z information for a gesture, a unique property of a pattern may not be impaired, even if the location of the electronic device changes (for example, the electronic device is horizontal or inclined) or the same gesture is input several times.

For example, when a star-shaped pattern is input, it may be recognized that the same star-shaped pattern is input, even if the starting point is different, as illustrated in FIG. 3F.

As another example, when a circular pattern is input, the electronic device may recognize the same circular pattern input, regardless of whether the user draws a circle once or three times, as illustrated in FIG. 3G.

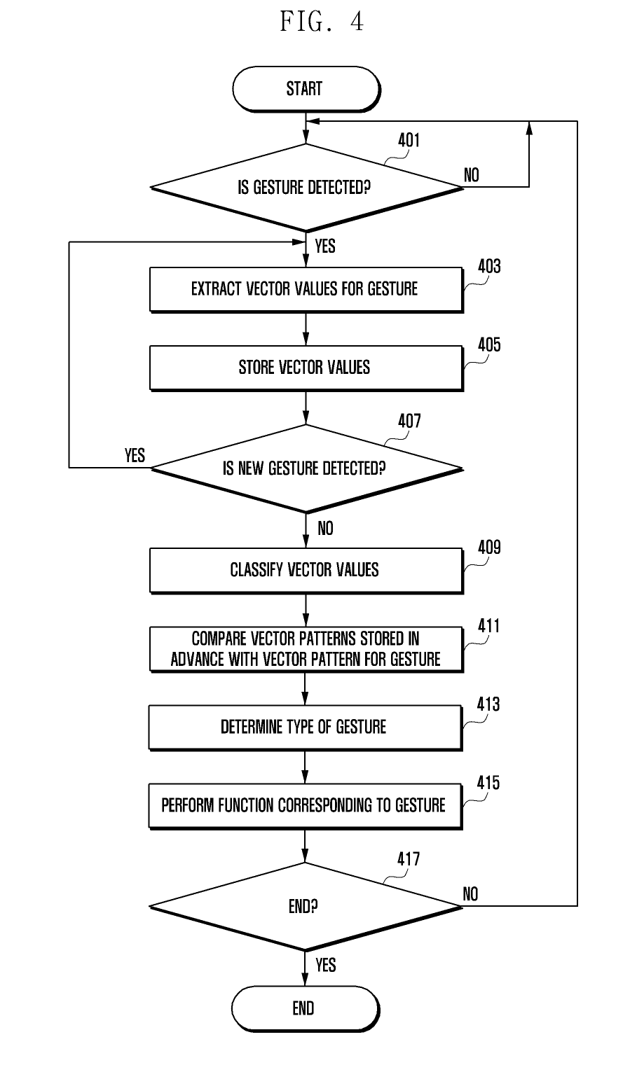

FIG. 4 is a flowchart illustrating a gesture recognition method according to an embodiment of the present invention.

Referring to FIG. 4, the electronic device, e.g., the controller 210, determines whether a gesture is detected in step 401. For example, the gesture may include a touch gesture, a multi-gesture, and/or hovering. The electronic device may be horizontal or inclined. According to an embodiment of the present invention, a pattern for the detected gesture may be generated such that a function corresponding to the pattern is performed.

In step 403, the electronic device extracts a vector value for the gesture. In step 405, the electronic device stores the extracted vector value.

In step 407, the electronic device determines whether a new gesture is detected. If a new gesture is generated, the operation returns to steps 403 and 405 to repeat extracting and storing a vector value for the new gesture.

However, if a new gesture is not generated in step 407, the electronic device classifies the stored vector values. For example, classifying the vector values may be performed through the variance, deviation, and average of the vector values, and a pattern of the vector for the gesture may be formed through the classifying operation.

In step 411, the electronic device compares a pattern of a stored vector with a pattern of a vector for the detected gesture. For example, in the comparison operation, a distribution of the stored vector pattern stored may be compared with a distribution of a vector pattern for the detected gesture. Further, a sequence (e.g., a progress direction) in which the stored vector pattern is generated may be compared with the sequence in which a vector pattern for the gesture is generated.

In step 413, the electronic device determines a type of the gesture, based on the comparison of the vector to the stored vectors.

In step 415, the electronic device performs a function corresponding to the type of the gesture.

The electronic device determines whether the function will end in step 417. For example, if an end instruction is generated, the electronic device detects the end instruction and ends the function. However, if an end instruction is not generated, the operation returns to step 401, and the electronic device detects if a gesture is detected.

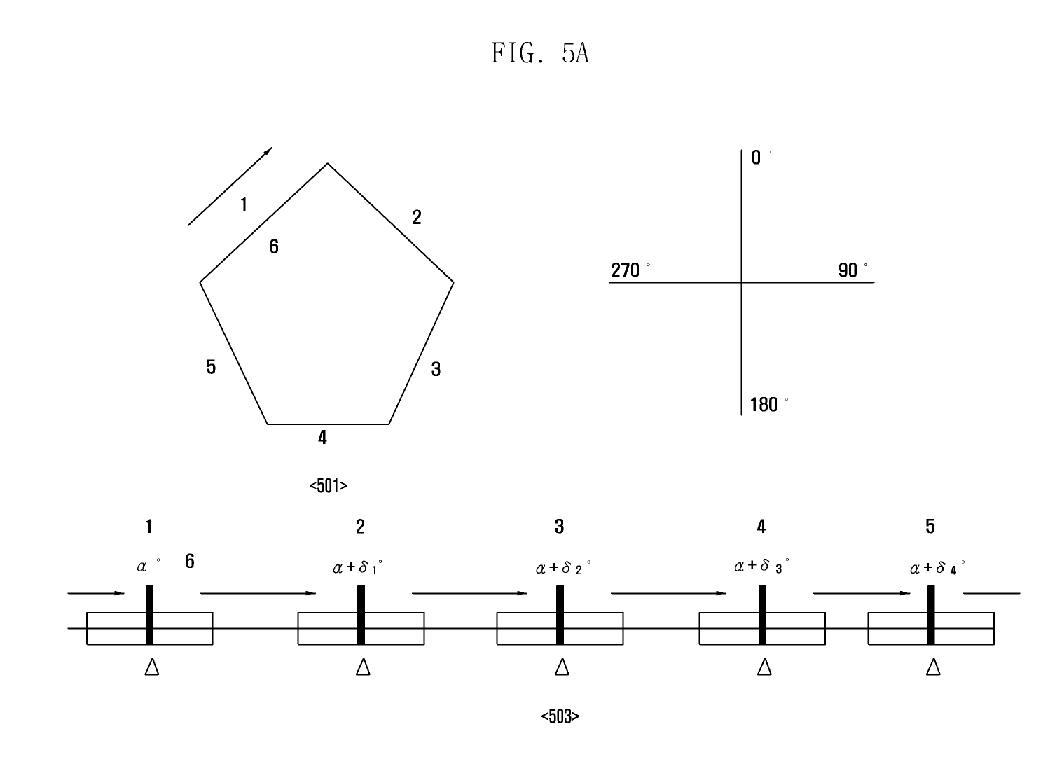

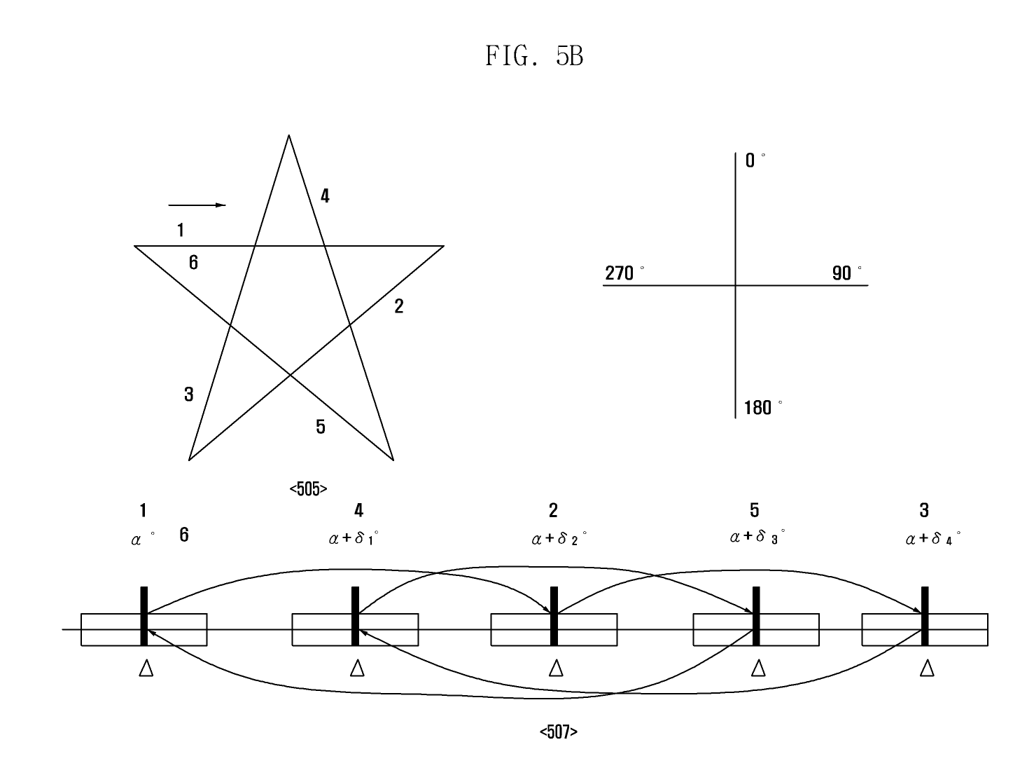

FIGS. 5A to 5B illustrate examples of a gesture recognition method according to an embodiment of the present invention. Specifically, FIG. 5A illustrates a distribution of vector values for a pentagonal pattern and a progress direction or sequence of the vector values for the pentagonal pattern gesture, and FIG. 5B illustrates a distribution of vector values for a star-shaped pattern and a progress direction or sequence of the vector values for the star-shaped pattern gesture.

Referring to FIG. 5A, as a first gesture 1 is generated, as indicated by reference numeral 501, a group of vectors for the first gesture may be generated in a predetermined range as indicated by “1” of reference numeral 503.

Thereafter, a new gesture, i.e., a second gesture 2 is generated, as indicated by reference numeral 501, a group of vectors for the second gesture may be generated in another range as indicated by “2” of reference numeral 503. Thereafter, as a third gesture 3 is generated, as indicated by reference numeral 501, a group of vectors for the third gesture may be generated as indicated by “3” of reference numeral 503, as a fourth gesture 4 is generated, as indicated by reference numeral 501, a group of vectors for a fourth gesture as indicated by reference 501 may be generated as indicated by “4” of reference numeral 503, and as a fifth gesture 5 is generated, as indicated by reference numeral 501, a group of vectors for a fifth gesture as indicated by reference numeral 501 may be generated as indicated by “5” of reference numeral 503. Further, as a sixth gesture 6 is generated, as indicated by reference numeral 501, a group of vectors for the sixth gesture may be generated as indicated by “6” of reference numeral 503.

When the group of vectors for the sixth gesture returns to a group of vectors of “1”, a pattern of the vectors for the gesture may be generated. The group of vectors for a pentagonal pattern may be defined, such that a variance thereof is a predetermined level or higher, and a progress direction of the group of the generated vectors may be constant. That is, the vector values for the gesture may be distributed, as indicated by reference numeral 503, and when a progress direction in which the vector values are generated is 1, 2, 3, 4, 5, and 6 (1), the gesture may be determined to be a pentagonal pattern.

Referring to FIG. 5B, as a first gesture 1 is generated, as indicated by reference numeral 505, a group of vectors for the first gesture 1 may be generated in a predetermined range, as indicated by “1” of reference numeral 507. When a new gesture, i.e., a second gesture 2, is generated, as indicated by reference numeral 505, a group of vectors for the second gesture 2 may be generated in another range as indicated by “2” of reference numeral 507. Thereafter, as a third gesture 3 is generated, as indicated by reference numeral 505, a group of vectors for the third gesture 3 may be generated as indicated by “3” of reference numeral 507, as a fourth gesture 4 is generated, as indicated by reference numeral 505, a group of vectors for the fourth gesture 4, as indicated by reference 505, may be generated as indicated by “4” of reference numeral 507, and as a fifth gesture 5 is generated, as indicated by reference numeral 505, a group of vectors for the fifth gesture 5, as indicated by reference numeral 505, may be generated as indicated by “5” of reference numeral 507. Further, as a sixth gesture 6 is generated, as indicated by reference numeral 505, a group of vectors for the sixth gesture 6, as indicated by reference numeral 505, may be generated as indicated by “6” of reference numeral 507.

When the group of vectors for the sixth gesture returns to the group of vectors of “1”, a pattern of the vectors for the gesture may be generated. The group of vectors for a star-shaped pattern may be defined, such that a variance thereof is a predetermined level or higher, and a progress direction of the group of the generated vectors may be constant. That is, the vector values for the gesture may be distributed, as indicated by reference numeral 507, and when a progress direction in which the vector values are generated is 1, 4, 2, 5, 3, and 6 (1), the gesture may be determined to be a star-shaped pattern. Although the distribution of the vector values for a pentagonal pattern, as indicated by reference numeral 503 of FIG. 5A, and the distribution of the vector values for a star-shaped pattern, as indicated by reference numeral 507, are similar, they may still be recognized as different patterns, when the progress directions of their vector values are compared, so that the electronic device may determine that the gesture illustrated in FIG. 5A corresponds to a pentagonal pattern and the gesture illustrated in FIG. 5B corresponds to a star-shaped pattern.

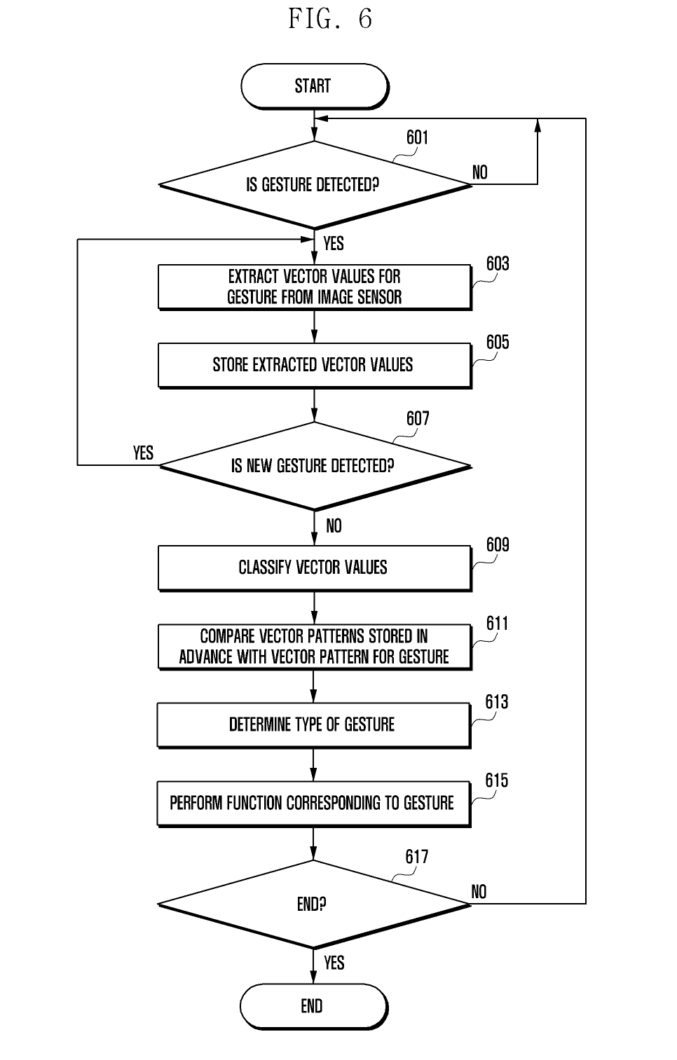

FIG. 6 is a flowchart illustrating a gesture recognition method according to an embodiment of the present invention.

Referring to FIG. 6, in step 601, the electronic device, e.g., the controller 210, determines whether a gesture is detected. Here, it is assumed that the gesture is a touch gesture.

In step 603, the electronic device extracts vector values for the gesture from an image sensor. Specifically, the vector values for the motion may be extracted by determining presence of a motion of an object (for example, a finger of the user or a stylus pen) detected by an image sensor.

In step 605, the electronic device stores the extracted vector values. In step 607, the electronic device determines whether a new gesture is detected. If a new gesture is generated, the operation returns to steps 603 and 605 to repeat the extracting and storing of a vector value for the new gesture from the image sensor.

However, if a new gesture is not generated in step 607, the electronic device classifies the stored vector values in step 609. For example, classifying the vector values may be performed through the variance, deviation, and average of the vector values, and a pattern of the vector for the gesture may be formed through the classifying operation.

In step 611, the electronic device compares a pattern of a stored vector stored with a pattern of a vector for the detected gesture. For example, in the comparison operation, a distribution of the stored vector pattern may be compared with a distribution of a vector pattern for the detected gesture, and a sequence (e.g., progress direction) in which the stored vector pattern is generated may be compared with a sequence in which a vector pattern for the detected gesture is generated. In step 613, the electronic device determines a type of the detected gesture, based on the comparison.

In step 615, the electronic device performs a function corresponding to the type of the gesture.

In step 617, the electronic device determines whether the function is completely performed. For example, if an end instruction is generated, the electronic device detects the end instruction and ends the function. However, if an end instruction is not generated in step 617, the operation returns to step 601.

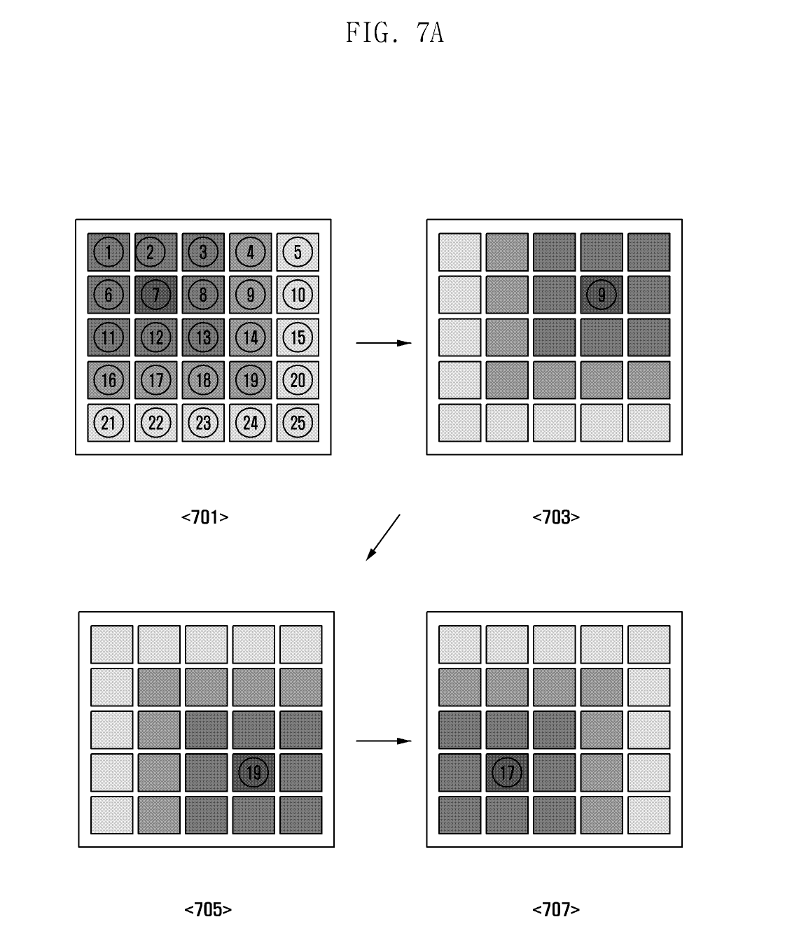

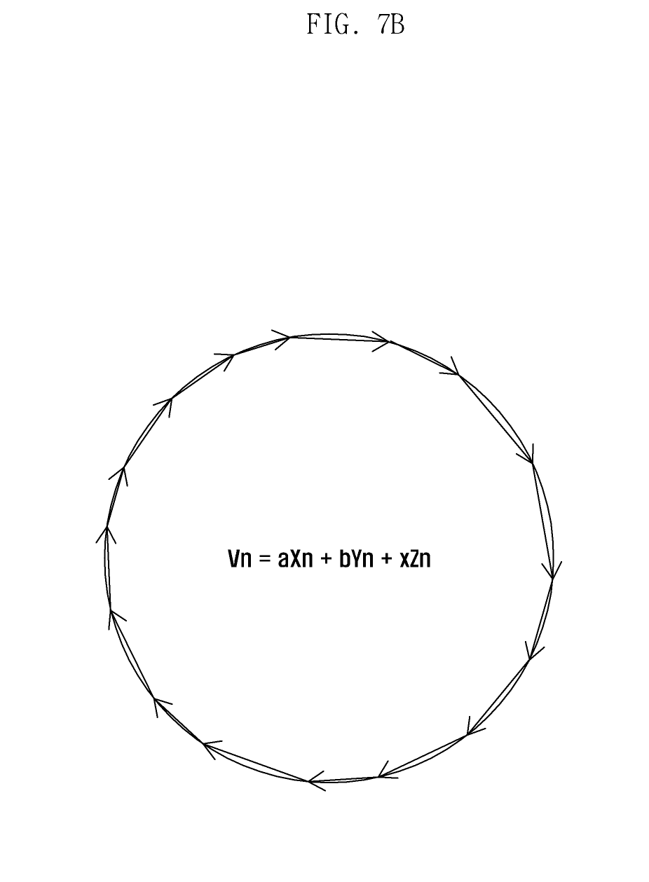

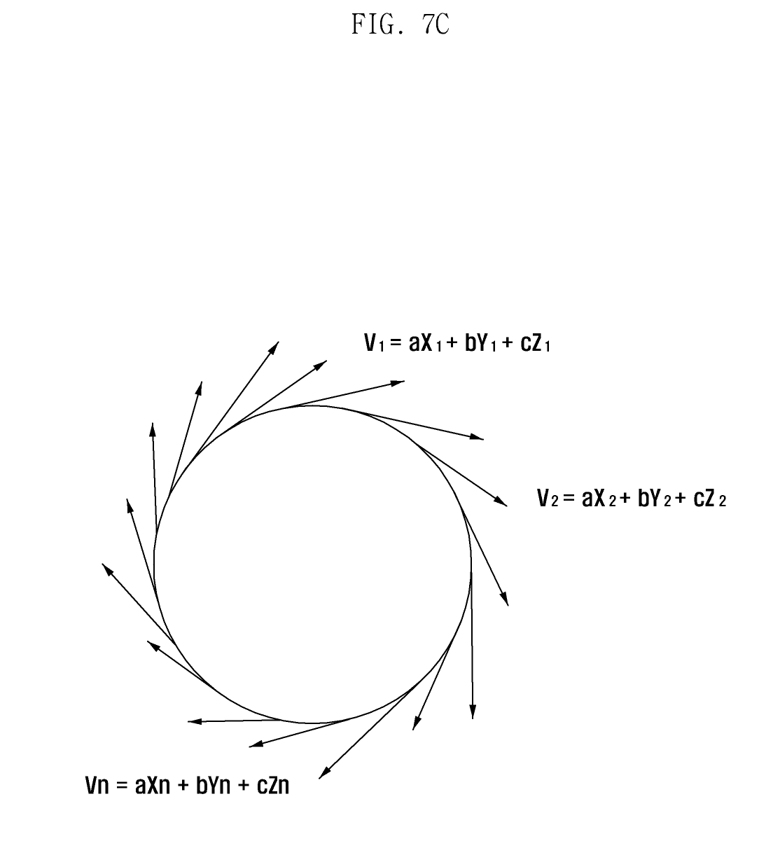

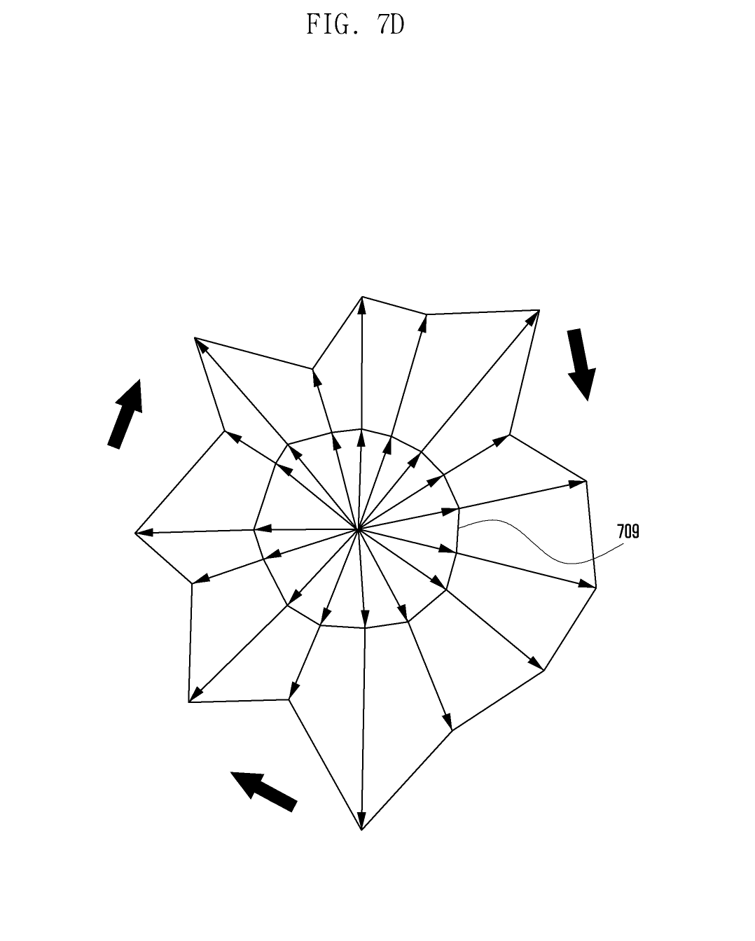

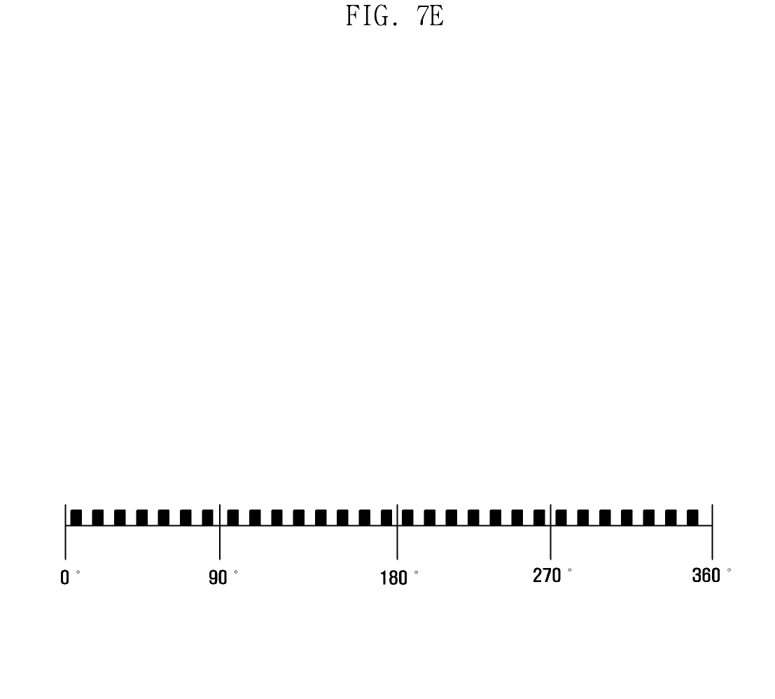

FIGS. 7A to 7E illustrate examples of a gesture recognition method according to an embodiment of the present invention.

Referring to FIG. 7A, which illustrates a gesture of a user being detected by an image sensor, a pattern will be described with the assumption that a touch screen is constituted in the form of a 5 by 5 sensor array including sensors 1-25. As indicated by reference numeral 701, sensor 7 being the darkest block means that a value reflected to the light receiving unit of sensor 7 by the image sensor is high, and this also means that an object, e.g., a finger of the user or a stylus pen, is present in sensor 7. Further, as indicated by reference numeral 703, the darkest spot moves from sensor 7 to sensor 9, indicating that the object is moved from sensor 7 to sensor 9. Similarly, as indicated by reference numerals 705 and 707, the object is moved from sensor 9 to sensor 19, and then from sensor 19 to sensor 17. That is, when it is detected that the object moves in the sequence from 7 (701) to 9 (703) to 19 (705), and then to 17 (707), the electronic device recognizes that the object moves clockwise, and may sample the motion in units of time and extract the location of the object to determine the gesture as a circular pattern.

FIGS. 7B and 7C illustrate a series of operational flows through a gesture of the user according to embodiments of the present invention.

Referring to FIG. 7B, the circular gesture has directionality, and one vector element of Vn=aXn+bYn+cZn (here, n is a natural number) may be acquired through coordinates of a measurement location during the previous sensing and a current measurement location. The vector information may constitute a set in the form of an array.

Additionally, as the sensing period becomes shorter, the vector information has attributes corresponding to an acceleration of motion.

Specifically, as illustrated in FIG. 7C, when a gesture has an acceleration attribute, one vector information element of Vn=aXn+bYn+cZn (here, a, b, and c are real numbers) may be acquired through a measurement location coordinate value during the previous sensing of V₁=aX₁+bY₁+cZ₁ and a coordinate value of a current measurement location of V₁=aX₂+bY₂+cZ₂ and a pattern of a vector for the gesture may be formed through an operation of classifying the acquired vector information element.

FIG. 7D is a diagram illustrating an arrangement of instantaneous vector information elements, and the vector information elements may be summed up, as indicated by reference numeral 709, by arranging the vector information elements such that directional elements of the vectors are obtained. As a result, the electronic device may detect that the vectors move clockwise, and the angular elements of the vector motion may be defined as one pattern. In the circular pattern, the vector values may be uniformly distributed as illustrated in FIG. 7E.

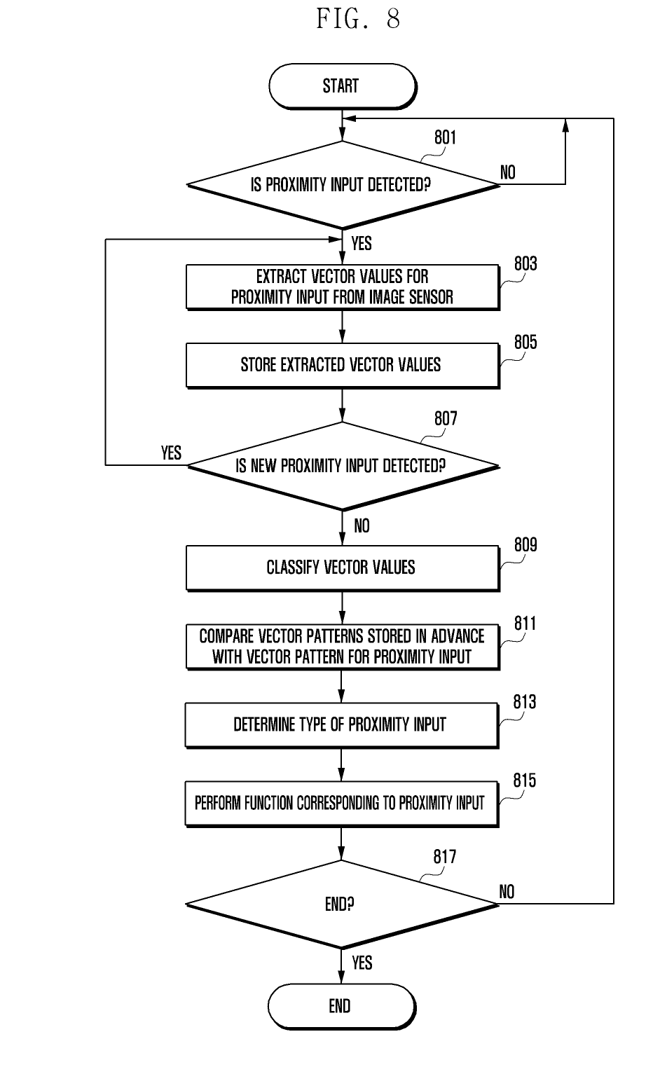

FIG. 8 is a flowchart illustrating a gesture recognition method according to an embodiment of the present invention.

Referring to FIG. 8, in step 801, the electronic device, e.g., the controller 210 thereof, determines whether a proximity input is detected. If the proximity input is detected, the electronic device extracts a vector value for the proximity input in step 803 and stores the extracted vector value in step 805.

In step 807, the electronic device determines whether a new proximity input is detected. If a new proximity input is generated, the operation returns to steps 803 and 805 to repeat the extracting and storing of a vector value for the new proximity input.

However, if a new proximity input is not generated in step 807, the electronic device classifies the stored vector values in step 809. For example, classifying the vector values may be performed through the variance, deviation, and average of the vector values, and a pattern of the vector for the proximity input may be formed through the classifying operation.

In step 811, the electronic device compares a pattern of a stored vector with a pattern of a vector for the detected proximity input. For example, in the comparison operation, a distribution of the stored vector pattern may be compared with a distribution of a vector pattern for the detected proximity input. Further, a sequence (e.g., a progress direction) in which the stored vector pattern is generated may be compared with a sequence in which the vector pattern for the detected proximity input is generated.

In step 813, the electronic device determines a type of the proximity input, based on the comparison, and in step 815, performs a function corresponding to the proximity input, based on the determined type.

In step 817, the electronic device determines whether the function is completely performed. For example, if an end instruction is generated in step 817, the electronic device detects the end instruction and ends the function. However, if an end instruction is not generated in step 817, the operation returns to step 801.

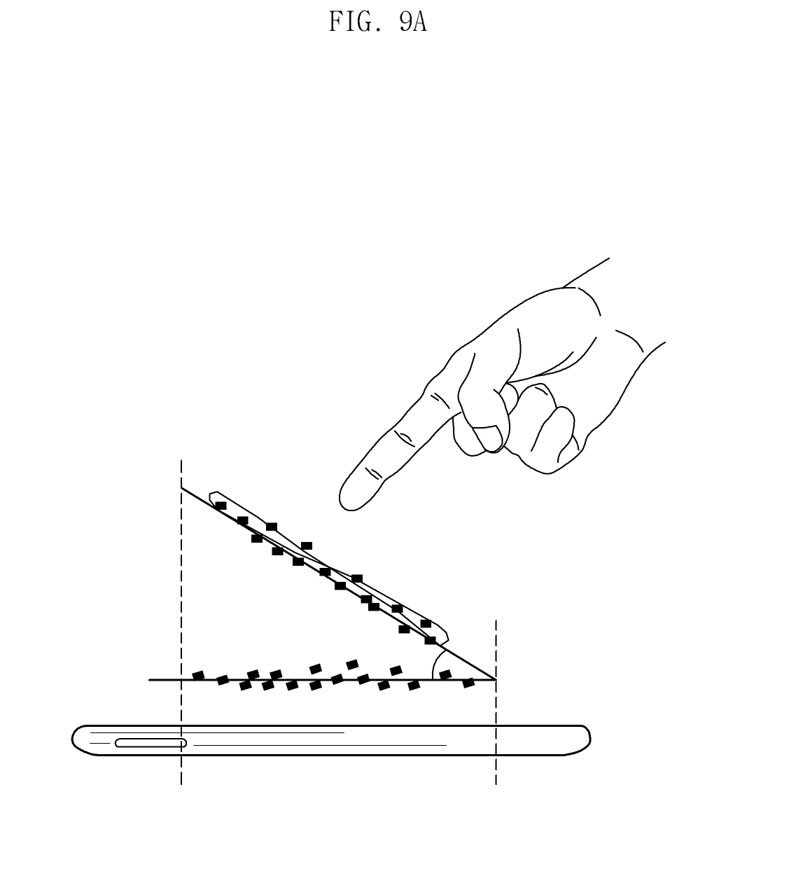

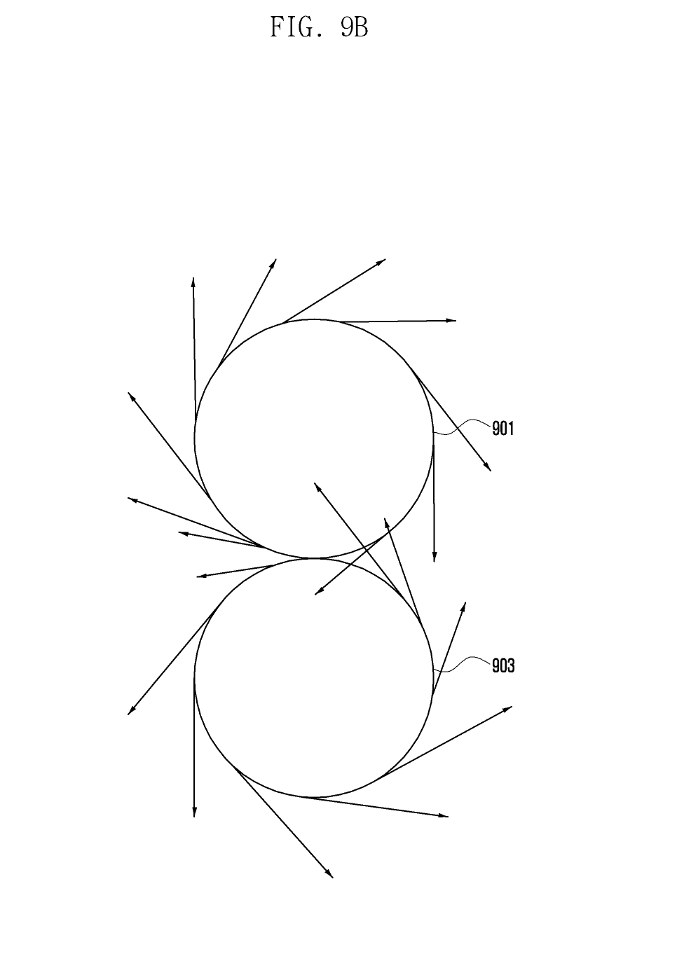

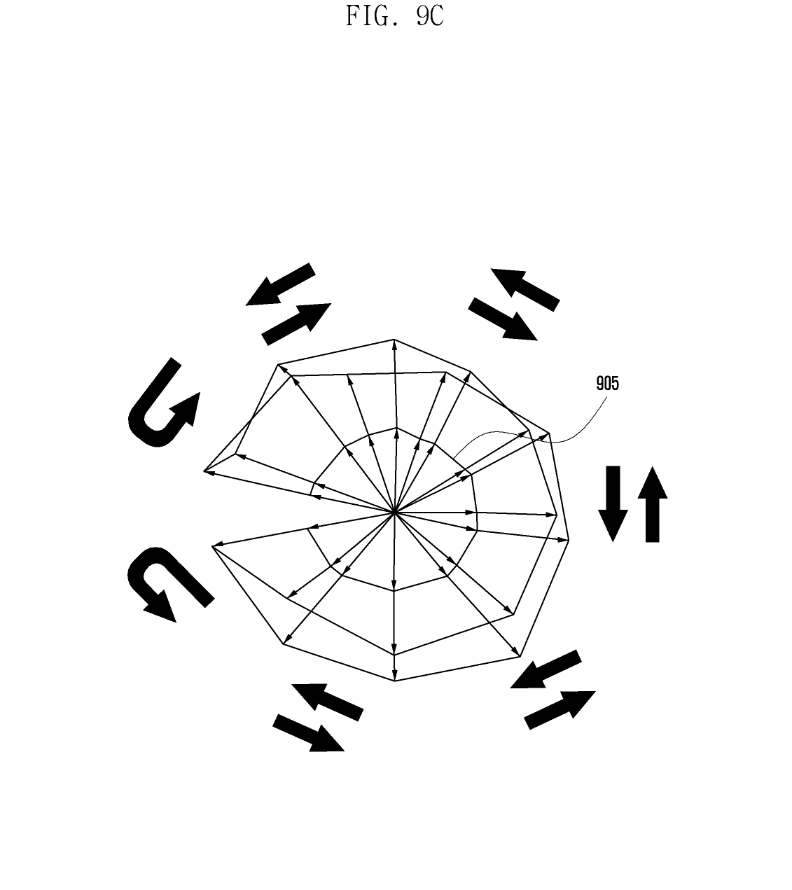

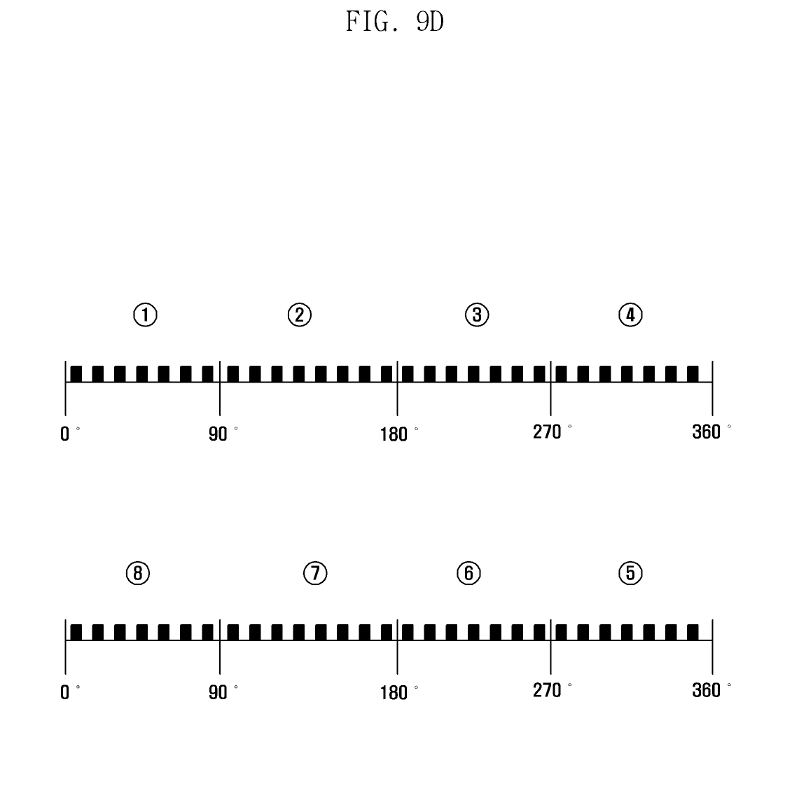

FIGS. 9A to 9D are diagrams illustrating a gesture recognition method according to an embodiment of the present invention. Specifically, FIGS. 9A to 9D will be described with the assumption that a proximity input having a figure 8-shaped pattern is generated.

Referring to FIG. 9A, the electronic device may identify that a proximity input having a figure 8-shaped pattern is detected, while the electronic device is inclined, i.e., while the hover input is on an angled plane from the touch screen of the electronic device.

Although the figure 8-shaped pattern is two attached circles as illustrated in FIG. 9B, the figure 8-shaped pattern may be identified as a counterclockwise motion made, as indicated by reference numeral 903, after a clockwise motion made, as indicated by reference numeral 901.

Further, the figure 8-shaped pattern may be identified from a clockwise motion of a unit vector and a counterclockwise motion as indicated by reference numeral 905 of FIG. 9C. That is, a phase may be defined such that as the figure 8-shaped pattern is generated, a progress direction of the vector values moves from 0 degrees to 360 degrees and then from 360 degrees to 0 degrees. Accordingly, it may be identified that the vector values of the figure 8-shaped pattern moves forwardly from 0 degrees to 360 degrees, as illustrated in FIG. 9D, and move in the reverse from 360 degrees to 0 degrees.

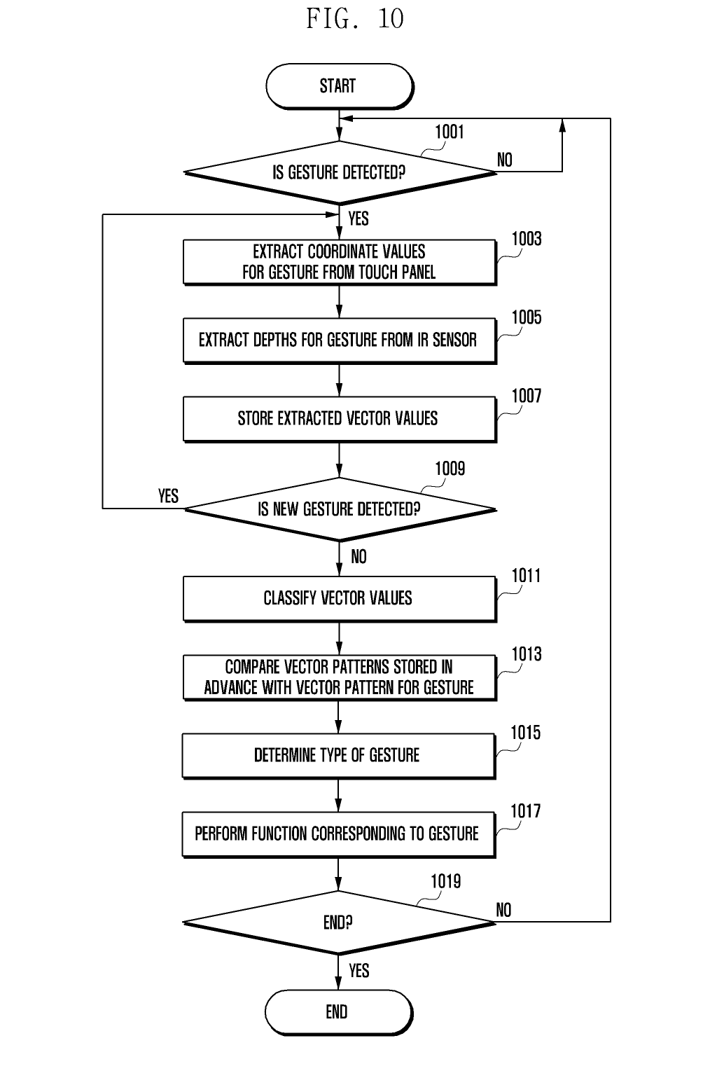

FIG. 10 is a flowchart illustrating a gesture recognition method according to an embodiment of the present invention.

Referring to FIG. 10, the electronic device, e.g., the controller 210 therein, determines whether a gesture is detected in step 1001. Here, it is assumed that the gesture is a touch gesture.

If a touch gesture is generated, the electronic device extracts a coordinate value (x,y) for the gesture from the touch panel in step 1003. In step 1005, the electronic device extracts a depth value (z) for the gesture, e.g., from an IR sensor. For example, the electronic device may detect a distance according to a degree by which an infrared ray projected from a light emitting unit is reflected by a finger and is introduced into a light receiving unit through the IR sensor, and may determine a motion of an object (e.g., a finger of the user or a stylus pen) using an intensity of the reflected light.

In step 1007, the electronic device stores the extracted vector values.

In step 1009, the electronic device determines whether a new gesture is detected. If a new gesture is detected in step 1009, the operation returns to steps 1003, 1005, and 1007 to extract a coordinate value and a depth for the new gesture and store the extracted values.

However, if a new gesture is not generated in step 1009, the electronic device classifies the stored vector values in step 1011. For example, classifying the vector values may be performed through the variance, deviation, and average of the vector values, and a pattern of the vector for the gesture may be formed through the classifying operation.

In step 1013, the electronic device compares a pattern of a stored vector with a pattern of a vector for the detected gesture. For example, in the comparison operation, a distribution of the stored vector pattern may be compared with a distribution of a vector pattern for the detected gesture, and a sequence (e.g., progress direction) in which the stored vector pattern was generated may be compared with a sequence (progress direction) in which the vector pattern for the detected gesture is generated.

In step 1015, the electronic device determines a type of the detected gesture, based on the comparison.

In step 1017, the electronic device performs a function corresponding to the gesture, based on the determined type.

In step 1019, the electronic device determines whether the function is completely performed. For example, if an end instruction is generated, the electronic device detects the end instruction and ends the function. However, if an end instruction is not generated in step 1019, the operation returns to step 1001.

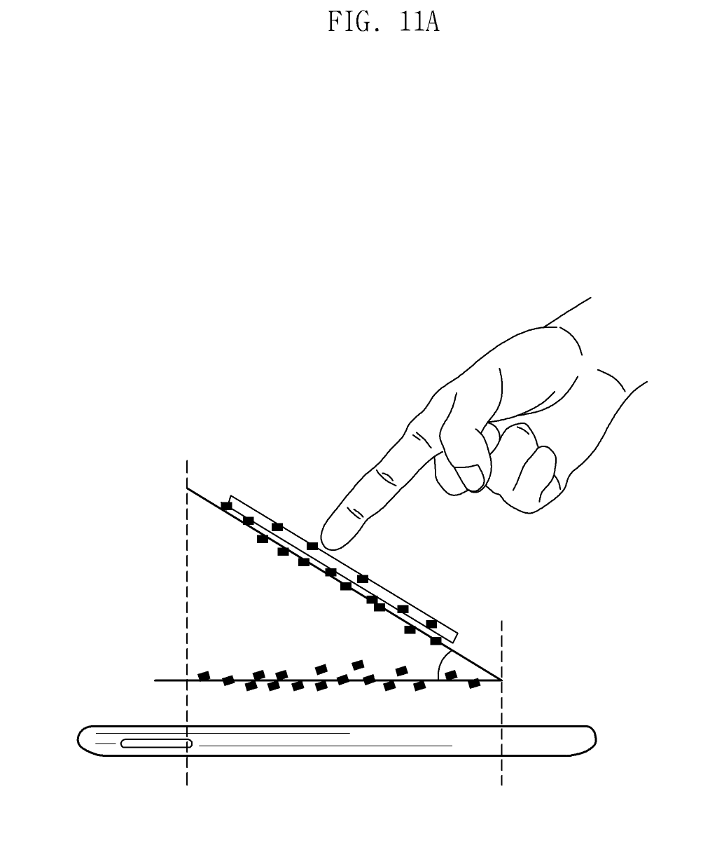

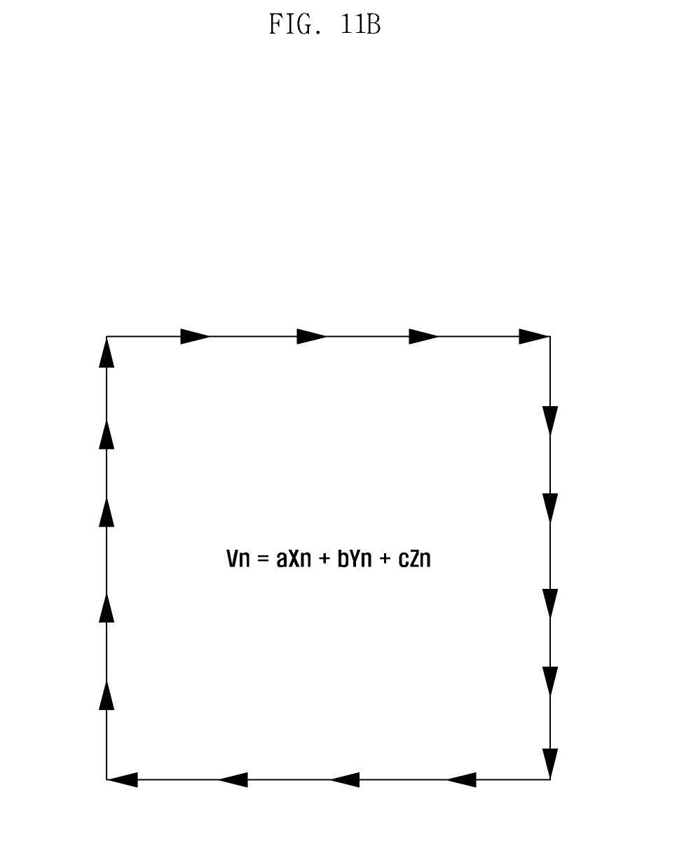

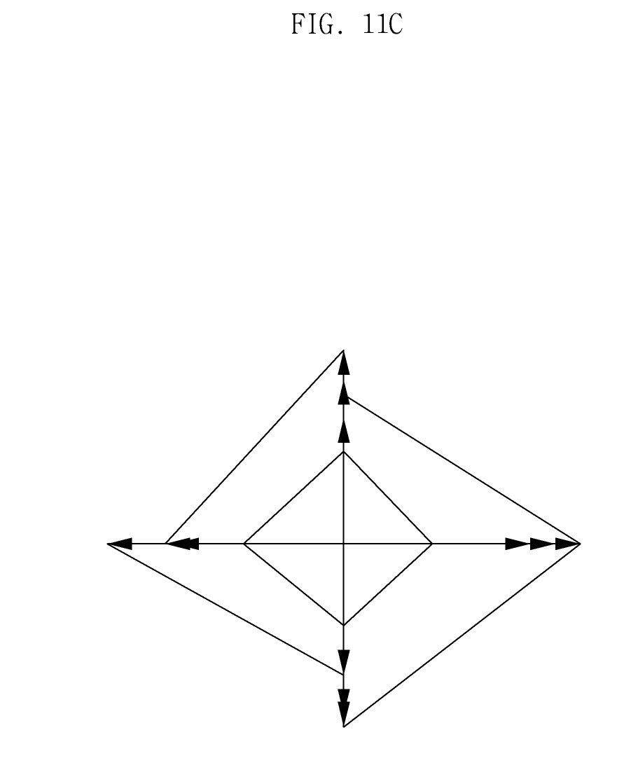

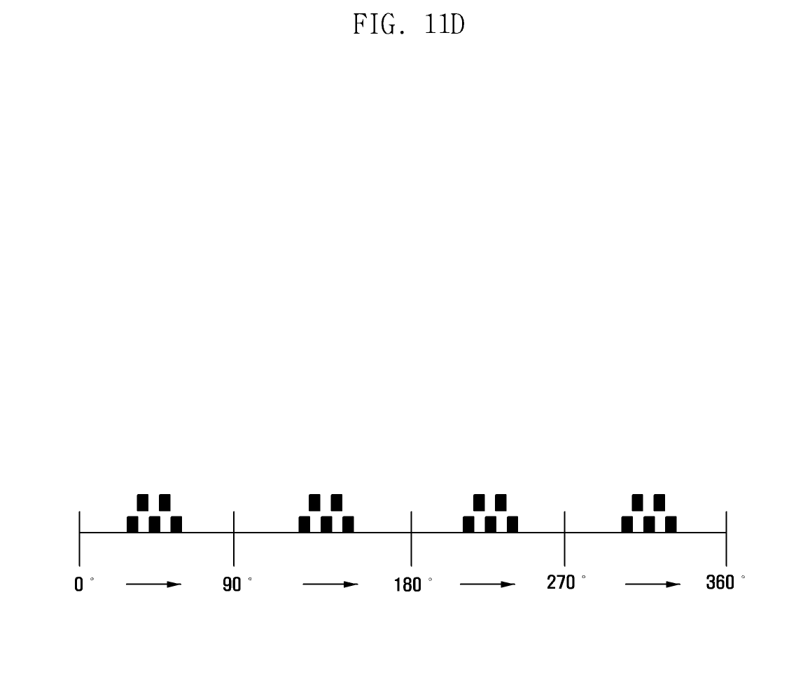

FIGS. 11A to 11D are diagrams illustrating a gesture recognition method according to an embodiment of the present invention.

Referring to FIG. 11A, the electronic device may detect a gesture having a four-sided pattern through the touch panel and the IR sensor. The four-sided pattern illustrated in FIG. 11B has a closed figure similar to a circular pattern, but its motion element may be different. Specifically, the electronic device may identify that the vector information of the circular pattern has a circular shape according to sensing, whereas the vector shapes of the four-sided pattern is concentrated at four portions. That is, the electronic device identifies locations according to vector angles are uniform in the gesture having a circular pattern, whereas motions are concentrated in vector angles of four portions in the gesture of the four-sided pattern, as illustrated in FIG. 11C, and are more extreme as compared with a circular pattern. Accordingly, this may be a feature by which a circular pattern and a four-sided pattern may be distinguished from each other.

Further, the electronic device may identify that the vector values for the four-sided pattern are partially distributed, as illustrated in FIG. 11D. That is, when a gesture having vector values, as illustrated in FIG. 11D, is generated, the gesture may be determined as a four-sided pattern.

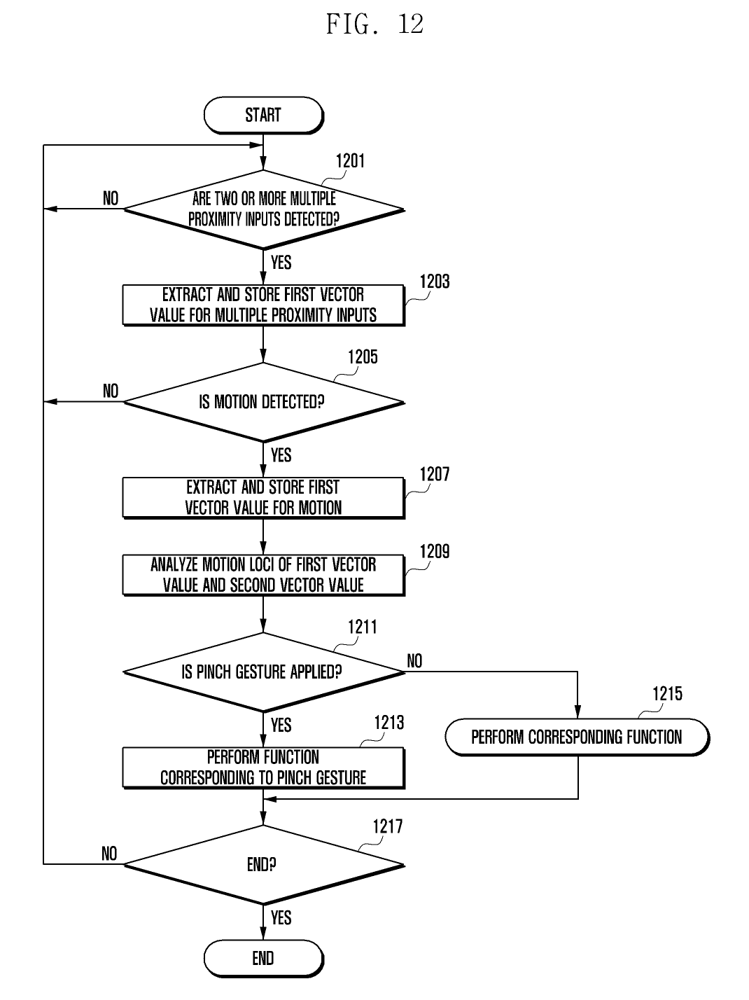

FIG. 12 is a flowchart illustrating a gesture recognition method according to an embodiment of the present invention.

Referring to FIG. 12, the electronic device, e.g., the controller 210 therein, determines whether two or more multiple proximity inputs are detected in step 1201. If the multiple proximity inputs are generated in step 1201, the electronic device extracts and stores a first vector value for the multiple proximity inputs in step 1203.

In step 1205, the electronic device determines whether a motion is generated while the multiple proximity inputs are generated. If a motion is generated in step 1205, the electronic device extracts and stores a second vector value for the motion in step 1207.

In step 1209, the electronic device analyzes motion loci of the first vector value and the second vector value.

In step 1211, based on the analysis of the motion loci, the electronic device determines if the gesture is a pinch gesture. For example, if a motion in the reverse direction is detected, while two multiple proximity inputs are generated between threshold values, the electronic device determines the multiple proximity inputs as a gesture.

When the pinch gesture is determined in step 1211, the electronic device performs a function for the pinch gesture in step 1213.

However, when the pinch gesture is not determined in step 1211, i.e., another gesture is input, the electronic device performs a corresponding function in step 1215.

In step 1217, the electronic device determines whether the function is completely performed. For example, if an end instruction is generated in step 1217, the electronic device detects the end instruction and ends the function. However, if an end instruction is not generated in step 1217, the operation returns to step 1201.

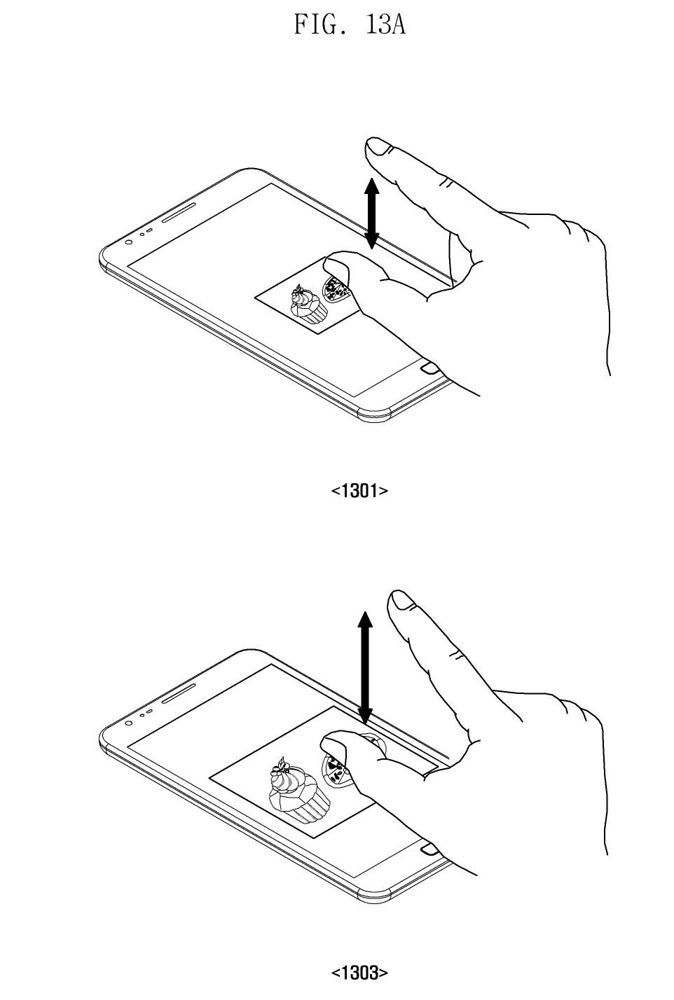

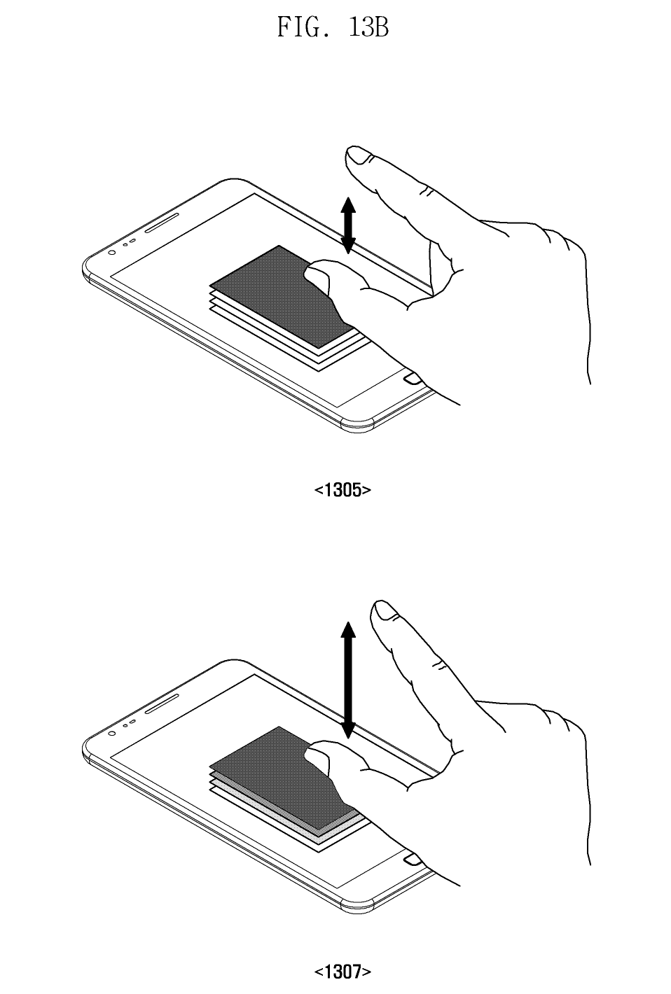

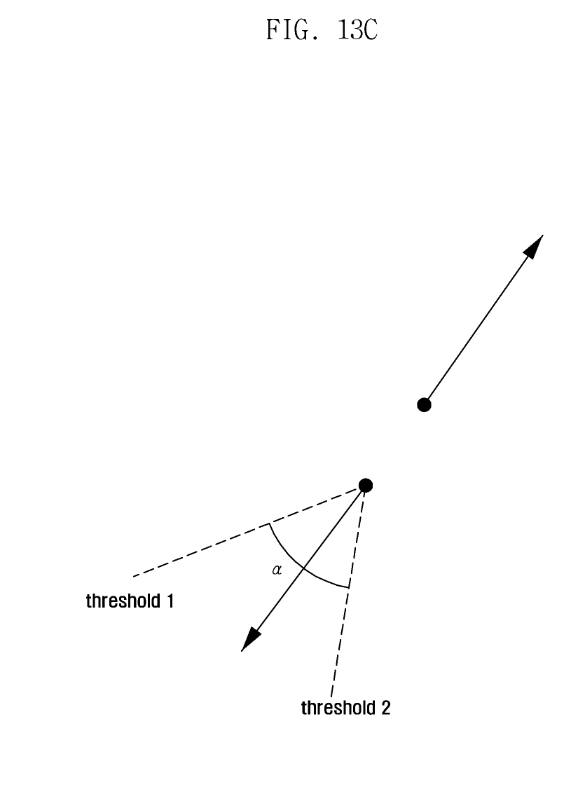

FIGS. 13A to 13C are diagrams illustrating a gesture recognition method according to an embodiment of the present invention. Specifically, FIGS. 13A to 13C illustrate a user performing a pinch gesture, slantingly through a hover input.

Referring to FIG. 13A, if a vector motion in the form of a pinch gesture, e.g., a pinch out gesture, as indicated by reference numeral 1303, is detected while multiple proximity inputs of the user are detected, as indicated by reference numeral 1301, the vector motion may be recognized as a pinch gesture, such that an operation according to the pinch gesture may be performed.

For example, FIG. 13C illustrates vector information of a pinch gesture, and if motions of two or more recognized multiple proximity inputs in the reverse direction are detected between threshold values, they may be recognized as a pinch regardless of directions. This may be expressed by Equation (1):

0<threshold 1<α<threshold 2 (1)

The gesture may be recognized as the same pinch as an X-Y axis based pinch gesture according to vector information of the gesture, and for example, a function of enlarging an image displayed on a screen may be performed.

Referring to FIG. 13B, according to another embodiment, if a pinch gesture, e.g., a pinch out gesture, is generated as indicated by reference numeral 1307, while multiple proximity inputs of the user are detected, as indicated by reference numeral 1305, are detected, a selection range of materials arranged on the Z-axis according to the gesture may be adjusted. Accordingly, if motions of the recognized two or more multiple proximity inputs in the reverse direction are detected, as illustrated in FIG. 13C, they may be recognized as a pinch, regardless of the directions. According to settings of the electronic device or the application, the motion vector of the gesture may be recognized as an X-Y value and may be recognized as a Z-axis vector value.

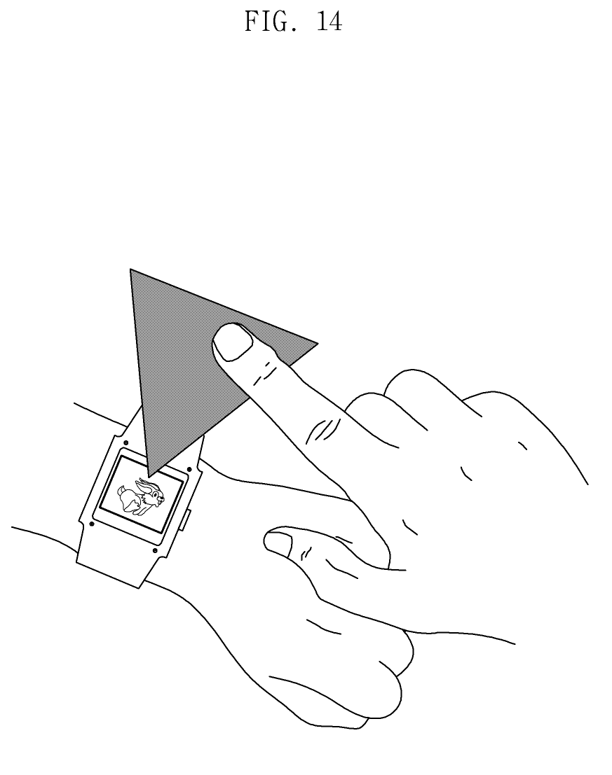

FIG. 14 illustrates a gesture recognition method according to an embodiment of the present invention.

Referring to FIG. 14, a gesture recognition method is utilized in a wearable device, for example, a smart watch.

Specifically, the wearable device may determine a gesture of the user through a gesture sensor, such as an IR sensor, hovering through a TSP, or an image sensor. The wearable device determines an object (for example, a finger of the user or a stylus pen) that is a motion target, when a gesture of the user is detected, and detects a motion of the object. When motion of the object is detected, the wearable device, e.g., the gesture recognition module 170 therein, detects motion on the z-axis corresponding to depth, and motions on the x and y axes. That is, when motion is detected while the gesture occurs, a vector value for the motion in the form of (x, y, z) may be extracted. The type of the gesture may be determined by comparing the vector value for a motion extracted through recognition of the gesture with a stored vector value, and a function corresponding to the gesture may then be performed, based on the determined type.

A gesture recognition method according to an embodiment of the present invention may include an operation of extracting one or more vector values for the gesture, an operation of generating a pattern of the vector based on the vector values, an operation of comparing one or more vector patterns with the generated pattern of the vector, and an operation of determining a type of the gesture, based on the comparison.

In accordance with an embodiment of the present invention, the vector value may include at least one phase value.

In accordance with an embodiment of the present invention, the operation of generating the pattern of the vector may include an operation of classifying the vector values through at least one of a variance, a deviation, and an average of the vector values.

In accordance with an embodiment of the present invention, in a comparison operation, the distribution of the vector values and the progress direction in which the vector values are generated may be compared.

In accordance with an embodiment of the present invention, in an extraction operation, when a new gesture is detected, one or more vector values for the new gesture may be extracted. As the new gesture is detected, the vector values for the new gesture may be accumulated and stored. The gesture may be detected through at least one of an image sensor, an IR sensor, and a touch panel.

A gesture recognition method according to an embodiment of the present invention may include operations of, when at least two multiple proximity inputs are detected, extracting at least one first vector value for the multiple proximity inputs, to, if a motion is generated while the multiple proximity inputs are detected, extracting at least one second vector value for the motion, analyzing motion loci of the first vector value and the second vector values, determining occurrence of a pinch gesture, and performing a function corresponding to the pinch gesture.

In the operation of performing the function corresponding to the pinch gesture at least one of functions of enlarging and reducing an image and adjusting a selection range of materials arranged in the Z-axis when the pinch gesture occurs may be performed.

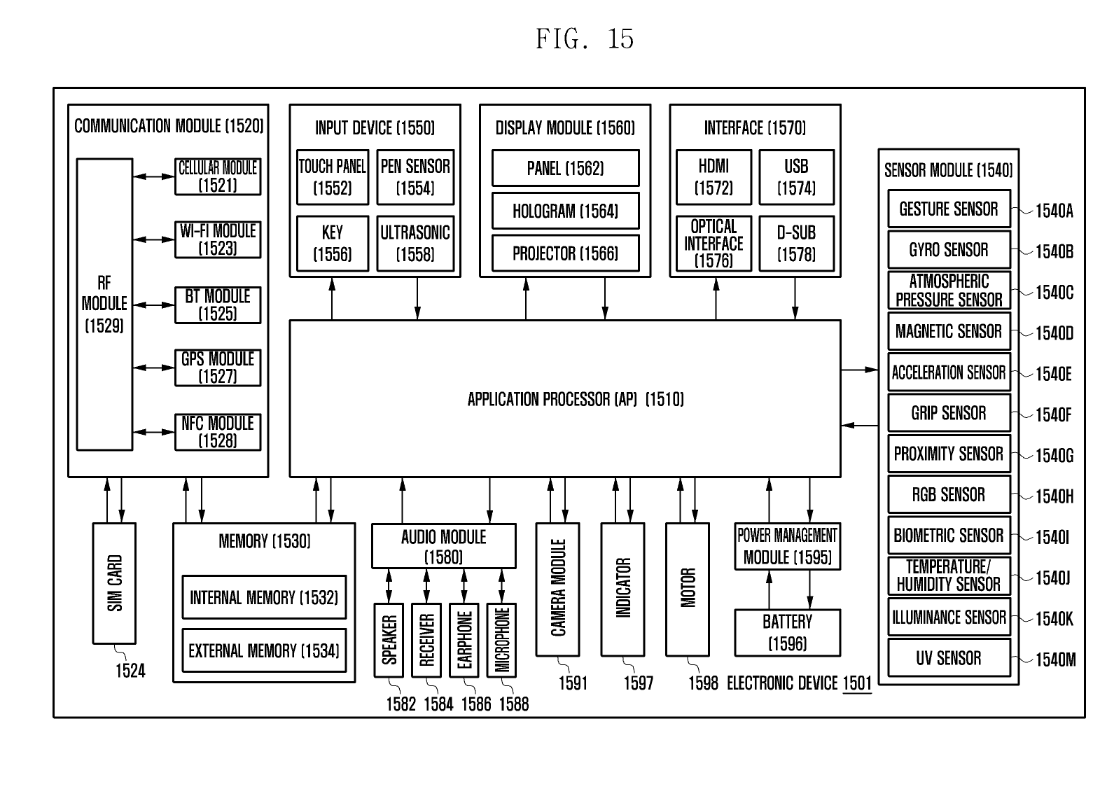

FIG. 15 illustrates a configuration of an electronic device according to an embodiment of the present invention. The electronic device 1501 of FIG. 15 may comprise the entire electronic device 101, or merely a part of the electronic device 101.

Referring to FIG. 15, the electronic device 1501 includes an Application Processor (AP) 1510, a communication module 1520, a Subscriber Identity Module (SIM) card 1524, a memory 1530, a sensor module 1540, an input device 1550, a display 1560, an interface 1570, an audio module 1580, a camera module 1591, a power management module 1595, a battery 1596, an indicator 1597, and a motor 1598.

The AP 1510 may operate an Operating System (OS) and/or application programs to control a plurality of hardware and/or software components connected to the AP 1510 and perform data-processing and operations on multimedia data. For example, the AP 1210 may be implemented in the form of a System on Chip (SoC). According to an embodiment, the AP 1510 may include a Graphic Processing Unit (GPU).

The communication module 1520 (similar to the communication interface 160) may perform data communication with other electronic devices through a network. According to an embodiment, the communication module 1520 may include a cellular module 1521, a Wi-Fi module 1523, a BT module 1525, a GPS module 1527, an NFC module 1528, and a Radio Frequency (RF) module 1529.

The cellular module 1521 is responsible for voice and video communication, text messaging, and Internet access services through a communication network (e.g. LTE, LTE-A, CDMA, WCDMA, UMTS, WiBro, and GSM networks). The cellular module 1521 may perform identification and authentication of electronic devices in the communication network using the SIM card 1524. According to an embodiment, the cellular module 1521 may perform at least one of the functions of the AP 1510. For example, the cellular module 1521 may perform at least a part of the multimedia control function.

The cellular module 1521 may include a Communication Processor (CP). The cellular module 1521 may be implemented in the form of an SOC. Although the cellular module 1521, the memory 1530, and the power management module 1595 are depicted as independent components separated from the AP 1510, the present invention is not limited thereto, but may be embodied such that the AP includes at least one of the other components.

Each of the AP 1510 and the cellular module 1521 may load a command or data received from at least one of the components on a non-volatile or volatile memory and process the command or data. The AP 1210 or the cellular module 1521 may store the data received from other components or generated by at least one of other components in the non-volatile memory.

Each of the Wi-Fi module 1523, the BT module 1525, the GPS module 1527, and the NFC module 1528 may include a processor for processing the data it transmits/receives. Although the cellular module 1521, the Wi-Fi module 1523, the BT module 1525, the GPS module 1527, and the NFC module 1528 are depicted as independent blocks; at least two of these components may be integrated in the form of an SoC.

The RF module 1529 is responsible for data communication, e.g., transmitting/receiving RF signals. Although not illustrated, the RF module 1529 may include a transceiver, a Power Amp Module (PAM), a frequency filter, and a Low Noise Amplifier (LNA). The RF module 1529 also may include the elements for transmitting/receiving electric wave in free space, e.g. conductor or conductive wire. Although FIG. 15 illustrates the Wi-Fi module 1523, the BT module 1525, the GPS module 1527, and the NFC module 1528 sharing the RF module 1529, the present invention is not limited thereto but may be embodied in a way that at least one of the Wi-Fi module 1523, the BT module 1525, the GPS module 1527, and the NFC module 1528 transmits/receives RF signals an independent RF module.

The SIM card 1524 may be designed so as to be inserted into a slot formed at a predetermined position of the electronic device. The SIM card 1524 may store unique identity information (e.g. Integrated Circuit Card Identifier (ICCID)) or subscriber information (e.g. International Mobile Subscriber Identity (IMSI)).

The memory 1530 (e.g. memory 130) includes the internal memory 1532 and an external memory 1534. The internal memory 1532 may include at least one of a volatile memory (e.g. Dynamic Random Access Memory (DRAM), Static

RAM (SRAM), Synchronous Dynamic RAM (SDRAM) or a non-volatile memory (e.g. One Time Programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, and NOR flash memory).

The internal memory 1532 may be a Solid State Drive (SSD). The external memory 1534 may be a flash drive such as Compact Flash (CF), Secure Digital (SD), micro-SD, Mini-SD, extreme Digital (xD), and Memory Stick. The external memory 1534 may be connected to the electronic device 1501 through various interfaces functionally. The electronic device 1501 may include a storage device (or storage medium) such as hard drive.

The sensor module 1540 may measure physical quantity or check the operation status of the electronic device 1501 and convert the measured or checked information to an electric signal. The sensor module 1540 includes a gesture sensor 1540A, Gyro sensor 1540B, atmospheric pressure sensor 1540C, magnetic sensor 1540D, acceleration sensor 1540E, grip sensor 1540F, proximity sensor 1540G, color sensor 1540H (e.g. Red, Green, Blue (RGB) sensor), biometric sensor 15401, temperature/humidity sensor 1540J, illuminance sensor 1540K, and Ultra Violet (UV) sensor 1540M. Additionally or alternatively, the sensor module 1540 may include E-nose sensor, Electromyography (EMG) sensor (not shown), Electroencephalogram (EEG) sensor, Electrocardiogram (ECG) sensor, Infrared (IR) sensor, iris sensor, and fingerprint sensor. The sensor module 1540 may further include a control circuit for controlling at least one of the sensors included therein.

The input device 1550 includes a touch panel 1552, (digital) pen sensor 1554, keys 1556, and an ultrasonic input device 1558. The touch panel 1552 may be one of capacitive, resistive, infrared, microwave type touch panel. The touch panel 1552 may include a control circuit. In the case of the capacitive type touch panel, it is possible to detect physical contact or approximation. The touch panel 1552 may further include a tactile layer. In this case, the touch panel 1552 may provide the user with haptic reaction.

The (digital) pen sensor 1554 may be implemented with a sheet with the same or similar way as touch input of the user or a separate recognition sheet. The keys 1556 may include physical buttons, optical key, and keypad. The ultrasonic input device 1558 is a device capable of checking data by detecting sound wave through a microphone 1588 and may be implemented for wireless recognition. The electronic device 1501 may receive the user input made by means of an external device (e.g. computer or server) connected through the communication module 1520.

The display module 1560 (similar to the display 150) includes a panel 1562. a hologram device 1564, and a projector 1566 The panel 1562 may be a Liquid Crystal Display (LCD) panel or an Active Matrix Organic Light Emitting Diodes (AMOLED) panel. The panel 1562 may be implemented so as to be flexible, transparent, and/or wearable. The panel 1562 may be implemented as a module integrated with the touch panel 1552. The hologram device 1564 may present 3-dimensional (3D) image in the air using interference of light. The projector 1566 may project an image to a screen. The screen may be placed inside or outside the electronic device. The display module 1560 may include a control circuit for controlling the panel 1562, the hologram device 1564, and the projector 1566.

The interface 1570 includes a High-Definition Multimedia Interface (HDMI) 1572, a Universal Serial Bus (USB) 1574, an optical interface 1576, and a D0subminiature (D-sub) 1578. The interface 1570 may include the communication interface 160, as illustrated in FIG. 1. Additionally or alternatively, the interface 1570 may include a Mobile High-definition Link (MHL) interface, a SD/MMC card interface, and Infrared Data Association (IrDA) standard interface.

The audio module 1580 may convert sound to electric signal and vice versa. At least a part of the audio module 1580 may be included in the input/output interface 140 as illustrated in FIG. 1. The audio module 1580 may process the audio information input or output through the speaker 1582, the receiver 1584, the earphone 1586, and the microphone 1588.

The camera module 1591 is a device capable of taking still and motion pictures and, according to an embodiment, includes at least one image sensor (e.g. front and rear sensors), a lens, and Image Signal Processor (ISP), and a flash (e.g. LED or xenon lamp).

The power management module 1595 may manage the power of the electronic device 1501. Although not illustrated, the power management module 1595 may include a Power Management Integrated Circuit (PMIC), a charger Integrated Circuit (IC), a battery, and a battery gauge.

The PMIC may be integrated into an integrated circuit or SoC semiconductor. The charging may be classified into wireless charging and wired charge. The charger IC may charge the battery and protect the charger against overvoltage or overcurrent. According to an embodiment, the charger IC may include at least one of wired charger and wireless charger ICs. Examples of the wireless charging technology includes resonance wireless charging and electromagnetic wave wireless charging, and there is a need of extra circuit for wireless charging such as coil loop, resonance circuit, and diode.

The battery gauge may measure the residual power of the battery 1596, charging voltage, current, and temperature. The battery 1596 may store or generate power and supply the stored or generated power to the electronic device 1501. The battery 1596 may include a rechargeable battery or a solar battery.

The indicator 1597 may display operation status of the electronic device 1501 or a part of the electronic device, booting status, messaging status, and charging status. The motor 1598 may converts the electronic signal to mechanical vibration. Although not shown, the electronic device 1501 may include a processing unit (e.g., GPU) for supporting mobile TV. The processing unit for supporting the mobile TV may be able to processing the media data abiding by the broadcast standards such Digital Multimedia Broadcasting (DMB), Digital Video Broadcasting (DVB), and media flow.

Each of the components of the electronic device according to the present disclosure may be implemented by one or more components and the name of the corresponding component may vary depending on a type of the electronic device. The hardware according to an embodiment of the present disclosure may include at least one of the above-described elements. Some of the above-described elements may be omitted from the hardware, or the hardware may further include additional elements. Further, some of the components of the electronic device according to the present disclosure may be combined to be one entity, which can perform the same functions as those of the components before the combination.

The term “module” used in the present disclosure may refer to, for example, a unit including one or more combinations of hardware, software, and firmware. The “module” may be interchangeably used with a term, such as unit, logic, logical block, component, or circuit. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present invention may be implemented by a command stored in a computer-readable storage medium in a programming module form. When the command is executed by one or more processors (for example, the controller 210), the one or more processors may execute a function corresponding to the command. The computer-readable storage medium may be, for example, the memory 130. At least a part of the programming module may be implemented (for example, executed) by, for example, the controller 210. At least some of the programming modules may include, for example, a module, a program, a routine, and a set of instructions or a process for performing one or more functions.

The computer-readable recording medium may include magnetic media such as a hard disk, a floppy disk, and a magnetic tape, optical media such as a Compact Disc Read Only Memory (CD-ROM) and a DVD, magneto-optical media such as a floptical disk, and hardware devices specially configured to store and perform a program instruction (for example, programming module), such as a

ROM, a RAM, a flash memory and the like. In addition, the program instructions may include high class language codes, which can be executed in a computer by using an interpreter, as well as machine codes made by a compiler. The aforementioned hardware device may be configured to operate as one or more software modules in order to perform the operation of the present invention, and vice versa.

The programming module according to the present invention may include one or more of the aforementioned components or may further include other additional components, or some of the aforementioned components may be omitted. Operations executed by a module, a programming module, or other component elements according to various embodiments of the present invention may be executed sequentially, in parallel, repeatedly, or in a heuristic manner. Further, some operations may be executed according to another order or may be omitted, or other operations may be added.

The present invention also provides a recording medium that is implemented to recognize a gesture, in which a program for extracting one or more vector values for a gesture, generating a pattern of a vector based on the vector values, comparing one or more patterns of vectors stored in advance with the generated pattern of the vector, and determining a type of the gesture based on the comparison is stored.

The electronic device according to an embodiment of the present invention can easily perform a function corresponding to a gesture by recognizing the same input at any angle, even if the user bends their wrist or corrects their posture to input a pattern. Because the user can input a pattern without considering a state of the electronic device, the input can be recognized at a high rate and can be made even in situations in which the input may not be easily made.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A gesture recognition method comprising:
extracting one or more vector values from an input gesture;
generating a pattern of a vector based on the extracted one or more vector values;
comparing the generated pattern to one or more patterns of stored vectors; and
determining a type of the input gesture based on the comparing.

2. The gesture recognition method of claim 1, wherein the one or more vector values comprise one or more phase values.

3. The gesture recognition method of claim 1, wherein generating the pattern of the vector comprises classifying the extracted one or more vector values.

4. The gesture recognition method of claim 3, wherein the extracted one or more vector values are classified based on a variance, a deviation, and an average of the extracted one or more vector values.

5. The gesture recognition method of claim 3, wherein classifying the generated pattern of the extracted one or more vector comprises comparing a distribution of the extracted one or more vector values and a progress direction in which the extracted one or more vector values are generated.

6. The gesture recognition method of claim 1, further comprising extracting one or more new vector values from a new input gesture.

7. The gesture recognition method of claim 6, further comprising storing and accumulating the one or more new vector values.

8. The gesture recognition method of claim 1, further comprising detecting the input gesture through at least one of an image sensor, an Infrared (IR) sensor, and a touch panel.

9. A gesture recognition method comprising:
detecting two or more multiple proximity inputs;
extracting one or more first vector values from the detected two or more multiple proximity inputs;
detecting a motion of the detected two or more multiple proximate inputs;
extracting one or more second vector values for the motion;
analyzing loci of the first vector values and the second vector values;
determining whether a pinch gesture is generated, based on the analyzed loci; and
if the pinch gesture is generated, performing a function corresponding to the pinch gesture.

10. The gesture recognition method of claim 9, wherein performing the function corresponding to the pinch gesture comprises at least one of functions of enlarging an image, reducing the image, and adjusting a selection range of materials arranged on the Z-axis.

11. A gesture recognition apparatus comprising:
a gesture recognition device; and
a controller that detects an input of a gesture through the gesture recognition device, extracts one or more vector values from the detected gesture, generates a pattern of a vector based on the extracted one or more vector values, compares the generated pattern of the vector to one or more patterns of stored vectors, and determines a type of the gesture, based on the comparison.

12. The gesture recognition apparatus of claim 11, wherein the extracted one or more vector values comprise one or more phase values.

13. The gesture recognition apparatus of claim 11, wherein the controller classifies the extracted one or more vector values based on at least one of a variance, a deviation, and an average of the extracted one or more vector values, when the pattern of the vector is generated.

14. The gesture recognition apparatus of claim 11, wherein the controller compares a distribution of the extracted one or more vector values and a progress direction in which the vector values are generated.

15. The gesture recognition apparatus of claim 11, wherein the controller extract one or more new vector values from a new gesture input through the gesture recognition device.

16. The gesture recognition apparatus of claim 15, wherein the controller accumulate and store the extracted one or more new vector values of the new gesture.

17. The gesture recognition apparatus of claim 11, wherein the gesture recognition device comprises at least one of an image sensor, an Infrared (IR) sensor, and a touch panel.

18. A gesture recognition apparatus comprising:
a gesture recognition device; and
a controller that detects two or more multiple proximity inputs through the gesture recognition device, extracts one or more first vector values for the multiple proximity inputs, detects a motion generated by the multiple proximate inputs, extracts one or more second vector values from the motion, analyzes loci of the first vector values and the second vector values, determines whether a pinch gesture is generated, based on the analyzed loci, and performs a function corresponding to the pinch gesture, when the pinch gesture is generated.

19. The gesture recognition apparatus of claim 18, wherein the function corresponding to the pinch gesture comprises at least one of enlarging an image, reducing the image, and adjusting a selection range of materials arranged in the Z-axis.
